(19) United States
(12) Patent Application Publication
(10) Pub. No.: US 2023/0201833 A1
(43) Pub. Date: Jun. 29, 2023

(54) MAGNETOFLUIDIC CARTRIDGES, DEVICES AND RELATED METHODS OF SAMPLE ANALYSIS

(71) Applicant: THE JOHNS HOPKINS UNIVERSITY, Baltimore, MD (US)

(72) Inventors: Tza-Huei Jeff WANG, Timonium, MD (US); Alexander Y. TRICK, Baltimore, MD (US); Fan-En CHEN, Baltimore, MD (US)

(73) Assignee: THE JOHNS HOPKINS UNIVERSITY, Baltimore, MD (US)

(21) Appl. No.: 17/999,677

(22) PCT Filed: May 27, 2021
(86) PCT No.: PCT/US2021/034617

§ 371 Date: Nov. 22, 2022

Related U.S. Application Data
(60) Provisional application No. 63/031,372, filed on May 28, 2020.

(51) Int. Cl. B01L 3/00; G01N 35/00

(52) U.S. Cl. CPC B01L 3/502761; B01L 3/502715; G01N 35/0098; B01L 2200/0647; B01L 2200/0684; B01L 2300/0816; B01L 2300/087; B01L 2300/0874; B01L 2300/1805; B01L 2400/043; B01L 2200/0689; B01L 2200/16

(57) ABSTRACT

Provided herein are magnetofluidic cartridges of use in a wide variety of sample analysis applications, including nucleic acid amplification assays. The magnetofluidic cartridges include sample inlet wells and sample analysis wells. Temperature sensitive materials are used to separate the sample inlet wells and sample analysis wells from one another prior to performing a given sample analysis application. Related magnetofluidic devices, kits, and methods are also provided.

### CROSS-REFERENCE TO RELATED APPLICATIONS

This application claims priority to U.S. Provisional Patent Application Ser. No. 63/031,372, filed May 28, 2020, the disclosure of which is incorporated herein by reference.

### STATEMENT REGARDING FEDERALLY SPONSORED RESEARCH OR DEVELOPMENT

This invention was made with government support under grant AI138978 awarded by the National Institutes of Health. The government has certain rights in the invention.

### SEQUENCE LISTING

The instant application contains a Sequence Listing which has been submitted electronically in ASCII format and is hereby incorporated by reference in its entirety. Said ASCII copy, created on May 25, 2021, is named 0184_0107-PCT_SL.txt and is 1,957 bytes in size.

### BACKGROUND

On-demand cartridges or devices for assessing biological, chemical, or molecular analytes typically involve stabilization of assay components and reagents to prevent loss of function during transport or storage. For practical implementation of assay stabilization to protect from chemical and/or physical degradation, the methods should allow for immediate activation of the assay when needed with minimal user intervention. Prolonged assay reagent storage is often accomplished with use of air-dried or lyophilized reagents that are reconstituted by the sample of interest or another shelf-stable buffer. Reconstitution is typically achieved by manual transfer of liquids, controlled pressurized flow, or automated dispensing through compression of blister packs or other mechanical apparatus [Smith, S., Sewart, R., Becker, H., Roux, P. & Land, K. Blister pouches for effective reagent storage on microfluidic chips for blood cell counting. Microfluid. Nanofluidics 20:1-14 (2016)]. Prior to mixing with the final assay reagents, the sample often also involves upstream purification or concentration of the targeted analyte. Manual transfer of buffers or samples to extract analytes and rehydrate reagents may be prohibitively labor-intensive and prone to user-error, while automated dispensing of liquids using blister packs or machines like pipetting-robots often require complex and costly fluidics instrumentation and controllers with multiple moving parts or expensive high-precision microchannels.

Recent developments in in vitro diagnostics research have produced “droplet magnetofluidic” cartridges or scaffolds that obviate the need for complex fluidics and instrumentation while providing the user with sample-in, answer-out functionality [Shin, D. J., Trick, A. Y., Hsieh, Y.-H., Thomas, D. L. & Wang, T.-H. Sample-to-Answer Droplet Magnetofluidic Platform for Point-of-Care Hepatitis C Viral Load Quantitation. Sci. Rep. 8:1-12 (2018) and Shin, D. J. et al. Mobile nucleic acid amplification testing (mobiNAAT) for Chlamydia trachomatis screening in hospital emergency department settings. Sci. Rep. 7:4495 (2017)]. Reagents are pre-stored within chambers in the cartridges and covered with an immiscible layer of oil. Capture and transfer of analytes throughout the assay reagents is achieved with magnetic manipulation of functionalized particles between chambers through the oil. Due to the simplicity of design and assembly, these cartridges are promising as an affordable alternative to the current state-of-the-art diagnostics instruments and cartridges. Despite the convenience and simplicity of the magnetofluidic technology, previous work lacked provisions for prolonged shelf-life at ambient temperatures and stable transport without leakage of the oil and reagents.

Accordingly, there is a need for additional methods, and related aspects, for reagent storage and stabilization within automated assay magnetofluidic cartridges.

### SUMMARY

The present disclosure relates, in certain aspects, to methods that provide a thermally labile storage mechanism in magnetofluidic cartridges for physical and chemical stabilization of assay components with automated on-demand activation of a corresponding assay. Using a combination of wax seals (and/or other temperature sensitive materials) and pre-aliquoted buffers or other reagents in the magnetofluidic cartridges disclosed herein, essentially any reagents of a particular assay that are sensitive to time and/or temperature may be stored in a shelf-stable dry state with reconstitution mediated by application of a heat source to melt the wax or other temperature sensitive material. In some embodiments, for example, the disclosed magnetofluidic cartridges are used to automate the purification and detection of nucleic acids. These and other aspects will be apparent upon a complete review of the present disclosure, including the accompanying figures.

In one aspect, the present disclosure provides a magnetofluidic cartridge that includes a body structure that defines a channel and a plurality of wells disposed substantially within the body structure, wherein the channel is capable of fluidly communicating with the plurality of weds and wherein the plurality of wells comprises at least one sample inlet well and at least one sample analysis well. The magnetofluidic cartridge also includes at least one port disposed through a top surface of the body structure at least proximal to the sample inlet well, which port fluidly communicates with the channel, a sealing mechanism operably connected, or connectable, to at least the top surface of the body structure and/or the port, which sealing mechanism seals the port when the sealing mechanism is in a closed position, a plurality of magnetic particles disposed in at least the sample inlet well, and at least one processing reagent disposed in at least the sample analysis well and/or in at least one other chamber that fluidly communicates with the sample analysis well. In addition, the magnetofluidic cartridge also includes a first temperature sensitive material disposed in a substantially solid state in the channel between the sample inlet well and the sample analysis well and/or at least partially within the sample inlet well and/or the sample analysis well, which first temperature sensitive material fluidly partitions the sample inlet well and the sample analysis well from one another when the first temperature sensitive material is in the substantially solid state, and a sealing fluid disposed in at least a portion of the channel, which sealing fluid is immiscible with at least the plurality of magnetic particles and with the processing reagent.

In another aspect, the present disclosure provides a magnetofluidic cartridge that includes a top layer, a bottom layer spaced apart from the top layer in a generally parallel orientation with respect to the top layer, which bottom layer defines a plurality of wells that protrude from a surface of the bottom layer, wherein the plurality of wells comprises at least one sample inlet well and at least one sample analysis well. The magnetofluidic cartridge also includes a spacer layer operably connected to the top and bottom layers, a channel defined by the top, bottom, and spacer layers, which channel is capable of fluidly communicating with the plurality of wells, and at least one port disposed through the top layer and at least proximal to the sample inlet well, which port fluidly communicates with the channel. The magnetofluidic cartridge also includes a sealing mechanism (e.g., a lid, a cap, or the like) operably connected, or connectable, to at least the top layer, which sealing mechanism seals the port when the sealing mechanism is in a closed position, a plurality of magnetic particles disposed in at least the sample inlet well, and at least one processing reagent (e.g., at least some reagents of a nucleic acid amplification reaction mixture) disposed in at least the sample analysis well. In addition, the magnetofluidic cartridge also includes a first temperature sensitive material disposed in a substantially solid state in the channel between the sample inlet well and the sample analysis well and/or at least partially within the sample inlet well and/or the sample analysis well, which first temperature sensitive material fluidly partitions the sample inlet well and the sample analysis well from one another when the first temperature sensitive material is in the substantially solid state, and a sealing fluid disposed in at least a portion of the channel, which sealing fluid is immiscible with at least the plurality of magnetic particles and the processing reagent. In some aspects, the present disclosure provides a kit that includes the magnetofluidic cartridge disclosed herein.

In another aspect, the present disclosure provides a magnetofluidic device that includes a cartridge assembly structured to accept and secure the magnetofluidic cartridge as described herein. The magnetofluidic device also includes a temperature modulation assembly arranged proximate to the cartridge assembly, which temperature modulation assembly comprises at least one heat source that selectively thermally communicates with one or more of the plurality of wells and/or the channel of the magnetofluidic cartridge. In some embodiments, for example, a temperature modulation assembly includes a thermoelectric element, a resistive heater, a heated air element, an electromagnetic radiation, and/or the like. The magnetofluidic device also includes a magnetic particle manipulation assembly arranged proximate to the cartridge assembly, which magnetic particle manipulation assembly comprises a pair of magnets arranged to be on opposing sides of the magnetofluidic cartridge and which are substantially aligned along a line that will be transverse to the magnetofluidic cartridge such that the line can be aligned with one or more of the plurality of wells in the magnetofluidic cartridge. The pair of magnets are moveable along the line relative to the magnetofluidic cartridge, or a strength of the pair of magnets is adjustable such that the plurality of magnetic particles when contained within the one or more wells can be drawn out of and back into the one or more wells during operation.

In another aspect, the present disclosure provides a method of detecting at least one biomolecule in a sample. The method includes loading the sample into a sample inlet well of a magnetofluidic cartridge as described herein, positioning the sealing mechanism in the closed position, and agitating the magnetofluidic cartridge such that the biomolecule binds to the plurality of magnetic particles to produce a bound biomolecule. In addition, the method also includes removing the first temperature sensitive material from partitioning the sample inlet well and the sample analysis well from one another (e.g., by raising the temperature at least proximal to the first temperature sensitive material such that the first temperature sensitive material at least partially melts), moving the bound biomolecule from the sample inlet well to the sample analysis well (e.g., using one or more magnets of a magnetofluidic device), and detecting the biomolecule and/or a molecule derived therefrom (e.g., an amplicon or the like) in the sample analysis well (e.g., while performing a nucleic acid amplification reaction and/or a protein analysis assay in the sample analysis well), thereby detecting the biomolecule in the sample. In some embodiments, the method includes tilting the magnetofluidic cartridge at least when removing the first temperature sensitive material from partitioning the sample inlet well and the sample analysis well from one another. For example, tilting the magnetofluidic cartridge typically allows for the heated first temperature sensitive material to rise in the cartridge such that the bound biomolecule can be moved from the sample inlet well to the sample analysis well.

The magnetofluidic cartridges disclosed herein include various embodiments. In some embodiments, for example, the first temperature sensitive material is insoluble in aqueous materials; less dense than at least the plurality of magnetic particles and the sealing fluid; less dense than a sample and assay reagents; in the substantially solid state at a temperature less than about 40° C.; and/or in at least a partially fluid state at a temperature more than about 40° C. (e.g., in a range of about 40 to about 70° C. in some embodiments).

In some embodiments, the plurality of wells further comprises at least one overflow reservoir that is structured to receive excess sample, when the sample is received in the sample inlet well through the port. In some embodiments, the magnetofluidic cartridge also includes at least one vent orifice disposed through at least a portion of the body structure or through at least one layer, which vent orifice fluidly communicates with the channel and is structured to vent one or more gases from the channel at least when the magnetofluidic cartridge is heated (e.g., to prevent the cartridge from bursting, samples being unintentionally contacted with other reagents, etc.). In some embodiments, the magnetofluidic cartridge also includes at least one filter (e.g., a sintered polyethylene filter, a polytetrafluoroethylene (PTFE) membrane, or the like) disposed at least proximal to the vent orifice, which filter is structured to substantially prevent leakage of fluidic material from the channel through the vent orifice. In some of these embodiments, the vent orifice and the channel fluidly communicate with one another via at least one vent channel.

In some embodiments, the first temperature sensitive material fluidly partitions the sample inlet well and the sample analysis well from one another when the first temperature sensitive material is in the substantially solid state to produce a first region that comprises the sample inlet well and at least a first portion of the channel and a second region that comprises the sample analysis well and at least a second portion of the channel, and wherein the sealing fluid is disposed at least in the second portion of the channel of the second region such that the processing reagent is substantially contained within the sample analysis well.

In certain embodiments, the first temperature sensitive material is wax. In some embodiments, the wax is selected from the group consisting of: a higher alkane (e.g., docosane, tetracosane, octacosane, or the like), a paraffin wax, a beeswax, a carnauba wax, a candelilla wax, and a ceresin wax. In some embodiments, the sealing fluid is a hydrophobic fluid.

In some embodiments, the magnetic particles comprise a plurality of magnetic beads. In certain embodiments, the magnetic particles comprise a plurality of magnetic nanoparticles. In some of these embodiments, for example, the plurality of magnetic particles is coated magnetic nanoparticles that are coated with a coating material that electrostatically binds nucleic acids. In some embodiments, for example, magnetic particles are coated with silica.

In certain embodiments, at least one of the plurality of wells comprises a wall sufficiently thin to allow a heat transfer rate such that a nucleic acid amplification assay can be completed in less than 20 minutes. In some of these embodiments, a wall of at least one of the plurality of wells comprises a thickness of between about 0.05 mm and about 0.5 mm.

In some embodiments, the processing reagent is lyophilized. In certain embodiments, the processing reagent comprises a nucleic acid amplification reaction mixture. In some embodiments, the magnetofluidic cartridge further includes a second temperature sensitive material disposed in a substantially solid state at least proximal to the sample analysis well, which second temperature sensitive material fluidly partitions the processing reagent disposed in the sample analysis well and the sealing fluid disposed in the second portion of the channel of the second region from one another when the second temperature sensitive material is in the substantially solid state. In certain embodiments, for example, the second temperature sensitive material coats the processing reagent. In some of these embodiments, the magnetofluidic cartridge further includes at least one reconstitution buffer disposed in the sample analysis well, wherein the second temperature sensitive material separates the reconstitution buffer from the processing reagent.

In certain embodiments, the bottom layer further defines at least one sample washing well that protrudes from the surface of the bottom layer and fluidly communicates with the second portion of the channel of the second region. In some of these embodiments, the magnetofluidic cartridge also includes at least one washing buffer disposed in at least the sample washing well.

In some embodiments, the sealing fluid comprises a silicone oil. In certain embodiments, the plurality of magnetic particles is in a dried state. In some of these embodiments, for example, the plurality of magnetic particles is lyophilized. In some embodiments, the magnetofluidic cartridge also includes at least one control reagent disposed in at least the sample inlet well, which control reagent is in a dried state. In certain of these embodiments, for example, the control reagent is lyophilized. In certain embodiments, the magnetofluidic cartridge also includes at least one sample comprising at least one biomolecule disposed in the sample inlet well. In some of these embodiments, the biomolecule comprises at least one nucleic acid (e.g., DNA and/or RNA) and/or at least one protein or fragments thereof (e.g., antibodies, antigens, and/or the like). In certain embodiments, the magnetofluidic cartridge also includes at least one buffer, at least one salt, and/or at least one lytic reagent (e.g., a detergent, a surfactant, a chaotrope, an enzyme, and/or the like) disposed in the sample inlet well and/or disposed in an adjacent well/chamber/compressible blister in connection with the sample inlet well. In some embodiments, pH/salt conditions are adjusted to alter binding properties of the plurality of magnetic particles. In certain embodiments, lytic reagents are used to neutralize the activity of various sample components, lyse cells, disrupt viral envelopes, and/or the like.

### BRIEF DESCRIPTION OF THE DRAWINGS

The accompanying drawings, which are incorporated in and constitute a part of this specification, illustrate certain embodiments, and together with the written description, serve to explain certain principles of the methods, devices, kits, systems, and related computer readable media disclosed herein. The description provided herein is better understood when read in conjunction with the accompanying drawings which are included by way of example and not by way of limitation. It will be understood that like reference numerals identify like components throughout the drawings, unless the context indicates otherwise. It will also be understood that some or all of the figures may be schematic representations for purposes of illustration and do not necessarily depict the actual relative sizes or locations of the elements shown.

FIGS. 1A and B schematically show a magnetofluidic cartridge from side and top views, respectively, according to one exemplary embodiment.

FIG. 2A schematically shows a magnetofluidic device from a side view according to one exemplary embodiment.

FIG. 2B schematically shows a magnetofluidic cartridge from a side view according to one exemplary embodiment.

FIG. 2C schematically shows a magnetofluidic device from a side view according to one exemplary embodiment.

FIG. 3A is schematically shows the use of a magnetofluidic device according to one exemplary embodiment.

FIG. 3B is a flow chart that schematically shows exemplary method steps of detecting biomolecules in a sample according to some aspects disclosed herein.

FIG. 4 schematically shows a magnetofluidic device from a perspective view according to one exemplary embodiment.

FIG. 5 (Panels a-d) schematically show magnetofluidic cartridge operation according to one exemplary embodiment. (a) A sample containing target analyte(s) resuspends magnetic beads, an internal control, and any necessary chemical reagents required for releasing the target analyte(s) and binding with the beads. (b) A lid is sealed onto the cartridge inlet to prevent sample and reagent leakage. (c) Application of a heat source to the first well promotes sample lysis and melts the wax seal to open up the cartridge for (d) magnetic transfer of the beads with captured nucleic acids into the remaining wells for purification and elution into the assay buffer.

FIG. 6 (Panels a-c) schematically show magnetofluidic cartridge assembly according to one exemplary embodiment. (a) The body of the cartridge is formed by joining a section of extruded wells with a “spacer” (b) Reagents are dispensed into wells for washing the magnetic beads and conducting the assay buffer for chemical reaction with the targeted analyte(s) followed by sealing with the cartridge top (c) Pre-stored reagents are physically stabilized in the wells with a layer of oil followed by injection of a molten wax plug to seal the oil and reagents from leaking out into the first well and out of the cartridge.

FIG. 7 (Panels a-c) schematically show sample processing in a magnetofluidic cartridge with dried reagents according to one exemplary embodiment. (a) Injection of sample onto dried magnetic particles and internal control pre-stored on the cartridge (b) Dried magnetic beads with ammonium phosphate for nucleic acid binding and internal control RNA pre-stored in the first cartridge well are resuspended with the addition of 2004 aqueous sample. The cartridge port used to inject the sample is sealed with a pressure-sensitive adhesive lid allowing the cartridge to be shaken to evenly distribute the beads and buffer. (c) Real-time fluorescence signal for synthetic SARS-CoV-2 RNA PCR run within the cartridge using the dried reagents for capture and transport compared to a direct spike benchtop PCR control.

FIG. 8 (Panels a-c) schematically show magnetofluidic cartridge assembly with dry assay storage according to one exemplary embodiment. (a) Assay reagents are air-dried or lyophilized within the cartridge well or deposited as a lyophilized pellet. (b) The dry assay reagents are coated with wax which provides a water-tight seal away from the reconstitution buffer dispensed on top of the wax. The remaining assembly of the cartridge with wash buffer and (c) oil and wax dispensing follows the same steps as FIG. 6.

FIG. 9 (Panels a-c) schematically show heat-mediated assay activation according to one exemplary embodiment. (a) At room temperature, the wax is below its melting temperature (Tm,wax) and maintains a solid seal around the dried assay reagents to prevent reconstitution by the rehydration buffer. Heating the well melts the wax, which can then float out of the well to be replaced by aqueous buffer, thus rehydrating and activation the assay reagents. (b) Assembly of wax-sealed lyophilized reagents with (1) deposition of a wax pellet, (2) melted wax seal over lyophilized reagents, (3) pre-dispensed rehydration buffer an oil in fully assembled cartridge, (4) melted wax indicated by the red arrow floats from the well enabling mixing of the buffer with dry reagents. (c) Real-time fluorescence signal from amplification of DNA targets directly spiked into PCR or captured, purified and transported magnetically within cartridge to PCR which had been stored dry and reconstituted by wax melting with pre-stored water.

FIGS. 10A and B schematically show a magnetofluidic cartridge from side and top views, respectively, according to one exemplary embodiment.

FIGS. 11A and B schematically show a magnetofluidic cartridge having a vent orifice from top and detailed views, respectively, according to one exemplary embodiment.

FIG. 12A schematically shows a magnetofluidic cartridge lacking a vent orifice from a side view according to one exemplary embodiment.

FIG. 12B schematically shows a magnetofluidic cartridge having a vent orifice from a side view according to one exemplary embodiment.

FIG. 13 (Panels a-c) schematically show multiplex PROMPT platform operation. a, A sample, either nasal swab eluate or saliva, is injected directly into the cartridge with magnetic beads followed by sealing the cartridge and inserting it into the instrument. After magnetofluidic sample preparation and PCR, the instrument reports the assay results on the built-in touchscreen within 30 minutes. b, Each PCR well contains two fluorescent probes in the FAM (green) or Cy5 (red) spectrum. Cartridges include a duplexed assay for the conserved N1 SARS-CoV-2 sequence and control RNA in the first well. The cartridge designed for detection of SARS-CoV-2 variants include a duplexed PCR assay in the second well with probes spanning regions that contain deletions in variants of concern. A lack of amplification in the second well indicates the presence of a mutation and can be used to classify the type of variant present. c, Cartridges designed for multiplexed detection of respiratory pathogens instead have a duplexed Influenza A and Influenza B PCR assay in the second well.

FIG. 14 (Panels a-e) schematically show a magnetofluidic cartridge design. a, The magnetofluidic cartridge contains preloaded assay reagents for sample purification and PCR. A layer of silicone oil fills the space within the cartridge between reagents, and a wax plug prevents the reagents from leaking during transport such that the first well remains empty for injection of the sample. b, The first well is heated to 100° C. for 80 seconds (i) to promote viral lysis for RNA capture and to release the wax plug at the base of the sample well to allow passage of magnetic beads. c, Bead transfer into the wash well promotes removal of salts, proteins, and other sample components that may inhibit PCR. d, Bead transfer into the PCR wells accompanied by heating to 55° C. (iii/iv) allows sequential elution of the captured RNA. e, Plot of the temperature of previously described steps for sample preparation followed by one-pot reverse transcription and PCR with real-time 2-color fluorescence detection of both reaction wells at each cycle.

FIG. 15 (Panels a-f) schematically show instrumentation for automated sample preparation and multi-elution. a, Fluorescence detection optics and heat blocks assembly. b, Servo motor arrangement for (1) mounting heat blocks onto the cartridge, (2) swiveling magnets to the top and bottom of the cartridge for bead extraction and introduction into wells, and (3) translating the magnet arm along the cartridge for bead transfer between wells. c, Rotation of the heat blocks mounts them onto the cartridge followed by sample well heating to promote sample lysis and melt the wax seal. d, Translation of the top magnet from the sample well to the wash well followed by swiveling the magnet arm to raise the bottom magnet pulls the beads into the wash buffer. e, Sequential transfer of beads into the first PCR well and then the second elutes captured RNA into both reactions. f, The first elution releases more RNA than the second elution with overall fraction of RNA released tunable by temperature of the buffer during elution. Both elution steps were run in triplicate at each temperature condition and shown here fit with a linear regression with 95% confidence interval bands.

FIG. 16 (Panels a-h) show magnetofluidic cartridge assay analytical sensitivity. a, Fluorescence images of PCR wells in the FAM and Cy5 channels taken at the annealing step for each cycle with corresponding real-time fluorescence curves plotted in (b). Solid lines and dotted lines in (b) correspond to the top and bottom wells respectively. Standard curves with Ct values and corresponding average of triplicate fluorescence curves with standard error are shown for SARS-CoV-2 (c-d), influenza A (e-f), and influenza B (g-h).

FIG. 17 (Panels a-f) show clinical sample validation. a-c, Ct values for swabs (n=116) and saliva samples (n=14) run in the PROMPT multiplexed respiratory panel cartridges. Each point represents one sample with positive (+) and negative (−) values determined by the benchtop comparator assay denoted by color. All reactions with undetectable amplification are plotted with a Ct of 50 or higher, d-f, Corresponding receiver operator curves for the SARS-Coil-2, Flu A, and Flu B cartridge assays.

### DEFINITIONS

In order for the present disclosure to be more readily understood, certain terms are first defined below. Additional definitions for the following terms and other terms may be set forth throughout the specification. If a definition of a term set forth below is inconsistent with a definition in an application or patent that is incorporated by reference, the definition set forth in this application should be used to understand the meaning of the term.

As used in this specification and the appended claims, the singular forms “a,” “an,” and “the” include plural references unless the context clearly dictates otherwise. Thus, for example, a reference to “a method” includes one or more methods, and/or steps of the type described herein and/or which will become apparent to those persons skilled in the art upon reading this disclosure and so forth.

It is also to be understood that the terminology used herein is for the purpose of describing particular embodiments only and is not intended to be limiting. Further, unless defined otherwise, all technical and scientific terms used herein have the same meaning as commonly understood by one of ordinary skill in the art to which this disclosure pertains. In describing and claiming the methods, magnetofluidic cartridges, magenetofluidic devices or systems, and component parts, the following terminology, and grammatical variants thereof, will be used in accordance with the definitions set forth below.

About: As used herein, “about” or “approximately” or “substantially” as applied to one or more values or elements of interest, refers to a value or element that is similar to a stated reference value or element. In certain embodiments, the term “about” or “approximately” or “substantially” refers to a range of values or elements that falls within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value or element unless otherwise stated or otherwise evident from the context (except where such number would exceed 100% of a possible value or element).

Amplifying: As used herein, “amplifying” or “amplification” in the context of nucleic acids refers to the production of multiple copies of a polynucleotide, or a portion of the polynucleotide, typically starting from a small amount of the polynucleotide (e.g., a single polynucleotide molecule), where the amplification products or amplicons are generally detectable. Amplification of polynucleotides encompasses a variety of chemical and enzymatic processes. The generation of multiple DNA copies from one or a few copies of a target or template DNA molecule during a polymerase chain reaction (PCR) or a ligase chain reaction (LCR) are forms of amplification. Amplification is not limited to the strict duplication of the starting molecule. For example, the generation of multiple cDNA molecules from a limited amount of RNA in a sample using RT-PCR is a form of amplification. Furthermore, the generation of multiple RNA molecules from a single DNA molecule during the process of transcription is also a form of amplification.

Biomolecule: As used herein, “biomolecule” refers to an organic molecule produced by a living organism. Examples of biomolecules, include macromolecules, such as nucleic acids, proteins, carbohydrates, and lipids.

Detect: As used herein, “detect,” “detecting,” or “detection” refers to an act of determining the existence or presence of one or more target biomolecules (e.g., nucleic acids, proteins, etc.) in a sample.

Mixture: As used herein. “mixture” refers to a combination of two or more different components.

Nucleic Acid: As used herein, “nucleic acid” refers to a naturally occurring or synthetic oligonucleotide or polynucleotide, whether DNA or RNA or DNA-RNA hybrid, single-stranded or double-stranded, sense or antisense, which is capable of hybridization to a complementary nucleic acid by Watson-Crick base-pairing. Nucleic acids can also include nucleotide analogs (e.g., bromodeoxyuridine (BrdU)), and non-phosphodiester internucleoside linkages (e.g., peptide nucleic acid (PNA) or thiodiester linkages). In particular, nucleic acids can include, without limitation, DNA, RNA, cDNA, gDNA, ssDNA, dsDNA, cfDNA, ctDNA, or any combination thereof.

Protein: As used herein, “protein” or “polypeptide” refers to a polymer of at least two amino acids attached to one another by a peptide bond. Examples of proteins include enzymes, hormones, antibodies, and fragments thereof.

Reaction Mixture: As used herein, “reaction mixture” refers a mixture that comprises molecules that can participate in and/or facilitate a given reaction or assay. To illustrate, a nucleic acid amplification reaction mixture generally includes a solution containing reagents necessary to carry out an amplification reaction, and typically contains primers, a biocatalyst (e.g., a nucleic acid polymerase, a ligase, etc.), dNTPs, and a divalent metal cation in a suitable buffer. A reaction mixture is referred to as complete if it contains all reagents necessary to carry out the reaction, and incomplete if it contains only a subset of the necessary reagents. It will be understood by one of skill in the art that reaction components are routinely stored as separate solutions or in lyophilized forms (e.g., in different wells of a given magnetofluidic cartridge), each containing a subset of the total components, for reasons of convenience, storage stability, or to allow for application-dependent adjustment of the component concentrations, and that reaction components are combined prior to the reaction to create a complete reaction mixture. Furthermore, it will be understood by one of skill in the art that reaction components are packaged separately for commercialization and that useful commercial kits may contain any subset of the reaction or assay components.

Sample: As used herein, “sample” means anything capable of being analyzed by the methods, cartridges and/or devices disclosed herein. Samples can include a tissue or organ from a subject; a cell (either within a subject; taken directly from a subject, or a cell maintained in culture or from a cultured cell line); a ceil lysate (or lysate fraction) or cell extract; or a solution containing one or more biomolecules derived from a cell or cellular material (e.g., a nucleic acid, a protein, etc.), which is assayed as described herein. A sample may also be any body fluid or excretion (for example, but not limited to, blood, urine, stool, saliva, tears, bile) that contains cells, cell components, or non-cellular fractions. Additional examples of samples include environment and forensic samples. Samples can also include infectious disease agents (e.g., bacteria, viruses, etc.) or plant matter, among other sample types.

### DETAILED DESCRIPTION

Devices used to detect the presence and/or quantity of a molecular analyte typically need sufficient stability of assay reagents until the time-of-use. The present disclosure provides methods for the enclosure of reagents in disposable scaffolds or cartridges that use thermally labile seals (e.g., temperature sensitive materials, such as wax) and/or dried assay components for enhanced stability during transport and storage. The methods for sealing and protecting reagents described herein provide an elegant alternative for providing on-demand assay cartridges with minimal complexity and moving parts needed for use. The methods and related aspects are typically implemented at the point-of-need for research and diagnostics in numerous fields including medical molecular tests for infectious diseases or assays for disease detection and/or genotyping in agriculture and livestock, among many other applications. These and other aspects will be apparent upon a complete review of the present disclosure.

This technology described herein builds off of previous disclosures of point-of-care magnetofluidic technology to enable a more robust product for stability during transport and room-temperature storage. Some of this previous technology is described in International Publication No. WO2019/213096 and in U.S. Pat. No. 9,463,461, the disclosures of which are incorporated by reference in their entirety.

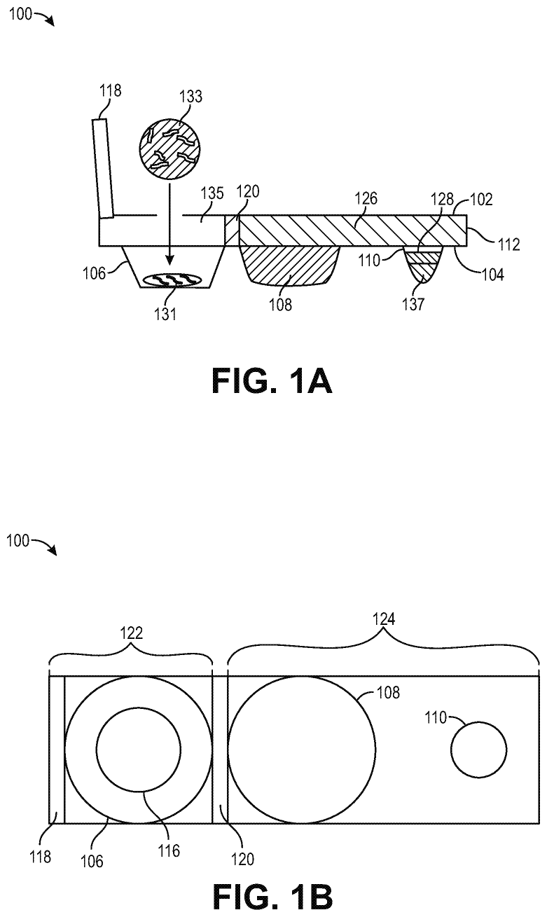

To illustrate, FIGS. 1A and B schematically show a magnetofluidic cartridge from side and top views, respectively, according to one exemplary embodiment. As shown, magnetofluidic cartridge 100 includes top layer 102 and bottom layer 104 spaced apart from top layer 102 in a generally parallel orientation with respect to top layer 102. Bottom layer 104 defines a plurality of wells that protrude from a surface of bottom layer 104. In some embodiments, at least one of the plurality of wells comprises a wall sufficiently thin (e.g., a thickness of between about 0.05 mm and about 0.5 mm) to allow a heat transfer rate such that a nucleic acid amplification assay can be completed in less than 20 minutes in magnetofluidic cartridge 100. The plurality of wells includes sample inlet well 106, wash buffer well 108 (e.g., comprising a washing buffer), and sample analysis well 110. Magnetic particles 131 (e.g., dried magnetic beads, magnetic nanoparticles, or the like) are disposed in sample inlet well 106. In some embodiments, other reagents such as internal controls are also included in sample inlet well 106. In certain embodiments, magnetic particles are first combined with samples prior to introduction into sample inlet well 106. To further illustrate, magnetic particles are coated magnetic nanoparticles that are coated with a coating material that electrostatically binds nucleic acids or other biomolecules in certain embodiments.

As further shown, processing reagent 137 is disposed in sample analysis well 110. The composition of processing reagent 137 depends on the particular assay to be performed in magnetofluidic cartridge 100. A wide variety of biomolecule detection assays are optionally performed using magnetofluidic cartridge 100. In some embodiments, for example, real-time nucleic acid amplification assays are performed using magnetofluidic cartridge 100. In these embodiments, processing reagent 137 typically includes nucleic acid amplification reaction mixture components (e.g., primers, probes, enzymes, nucleotides, etc.). In other exemplary embodiments, immunoassays are performed using magnetofluidic cartridge 100. In these embodiments, processing reagent 137 typically includes antibodies, antigens, and/or the like. Exemplary biomolecule detection assays and related upstream sample collection/preparation processes that are optionally adapted for use in the magnetofluidic cartridges disclosed herein are also described in, for example, Shen, Diagnostic Molecular Biology, 1st Edition, Academic Press (2019) and Rifai et al., Principles and Applications of Molecular Diagnostics, 1st Edition, Elsevier (2018). In some embodiments, processing reagents are disposed in sample analysis well 110 in a dried or lyophilized form, whereas in other embodiments processing reagents are disposed in sample analysis well 110 in a liquid form.

The methods disclosed herein optionally utilize various reaction mixtures that can be used in a wide variety of applications, particularly where it is desirable to determine the fractional abundance of target nucleic acids in amplification reactions. In some embodiments, for example, reaction mixtures are utilized in performing homogeneous amplification/detection assays (e.g., real-time PCR monitoring), or detecting mutations or genotyping nucleic acids. In certain embodiments, multiple primers and/or probes are pooled together in reaction mixtures for use in applications that involve multiplex formats. Many of these applications are described further herein.

In addition to the oligonucleotides (e.g., primers and probes), reaction mixtures also generally include various reagents that are useful in performing, e.g., nucleotide polymerization, nucleic acid amplification and detection reactions (e.g., real-time PCR monitoring or 5′-nuclease assays), and the like. Exemplary types of these other reagents include, e.g., template or target nucleic acids (e.g., obtained or derived from essentially any source), reference nucleic acids, nucleotides, pyrophosphate, light emission modifiers, biocatalysts (e.g., DNA polymerases, RNA polymerases, etc.), buffers, salts, amplicons, glycerol, metal ions (e.g., Mg⁺², etc.), dimethyl sulfoxide (DMSO), poly rA (e.g., as a carrier nucleic acid for low copy number targets), uracil N-glycosylase (UNG) (e.g., to protect against carry-over contamination). In some kinetic PCR-related applications, reaction mixtures also include probes that facilitate the detection of amplification products. Examples of probes used in these processes include, e.g., hybridization probes, exonuclease probes (e.g., 5′-nuclease probes), and/or hairpin probes.

Magnetofluidic cartridge 100 also includes spacer layer 112 operably connected to top and bottom layers 102 and 104, respectively. Channel 135 is defined by the top, bottom, and spacer layers 102, 104, and 112. As shown, channel 135 is capable of fluidly communicating with the plurality of wells. Magnetofluidic cartridge 100 also includes port 116 disposed through top layer 102 and at least proximal to sample inlet well 106. Port 116 fluidly communicates with channel 135.

As also shown, magnetofluidic cartridge 100 additionally includes sealing mechanism 118 operably connected (via a hinge) to top layer 102. Sealing mechanism 118 seals port 116 when sealing mechanism 118 is in a closed position. In some embodiments, sealing mechanisms are separate caps that are connectable to magnetofluidic cartridge 100. Sample 133 is introduced into sample inlet well 106 via port 116, for example, using a pipette or the like.

Magnetofluidic cartridge 100 also includes first temperature sensitive material 120 disposed in a substantially solid state in channel 135 between sample inlet well 106 and sample analysis well 110. First temperature sensitive material 120 fluidly partitions (e.g., seals) sample inlet well 106 and sample analysis well 110 from one another when first temperature sensitive material 120 is in the substantially solid state to produce first region 122 that comprises sample inlet well 106 and at least a first portion of channel 135 and second region 124 that comprises sample analysis well 110 and at least a second portion of channel 135. In addition, magnetofluidic cartridge 100 also includes sealing fluid 126 disposed at least in the second portion of channel 135 of second region 124. Sealing fluid 126 is immiscible with processing reagent 137 such that processing reagent 137 is substantially contained within sample analysis well 110. Sealing fluid 126 is typically a hydrophobic fluid, such as silicone oil or the like.

In some embodiments, magnetofluidic cartridge includes temperature sensitive or labile materials at more than one position. For example, magnetofluidic cartridge 100 also includes second temperature sensitive material 128 disposed in a substantially solid state at least proximal to sample analysis well 110. Second temperature sensitive material 128 fluidly partitions processing reagent 137 disposed in sample analysis well 110 and sealing fluid 126 disposed in the second portion of channel 135 of second region 124 from one another when second temperature sensitive material 128 is in the substantially solid state. In some embodiments, magnetofluidic cartridge 100 also includes comprising at least one reconstitution buffer disposed in sample analysis well 110. Second temperature sensitive material 128 separates the reconstitution buffer from processing reagent 137 in some of these embodiments.

Many different temperature or temperature labile materials are optionally used in the magnetofluidic cartridge disclosed herein. In some embodiments, for example, temperature sensitive materials (e.g., first temperature sensitive material 120 and/or second temperature sensitive material 128) are typically insoluble in aqueous materials; less dense than magnetic particles and sealing fluids; in the substantially solid state at a temperature less than about 40° C.; and/or in at least a partially fluid state at a temperature more than about 40° C. (e.g., in a range of about 40° C. to about 70° C. in some embodiments). In certain embodiments, temperature sensitive materials are a wax, such as a higher alkane (e.g., docosane), a paraffin wax, a beeswax, a carnauba wax, a candelilla wax, a ceresin wax, and/or the like.

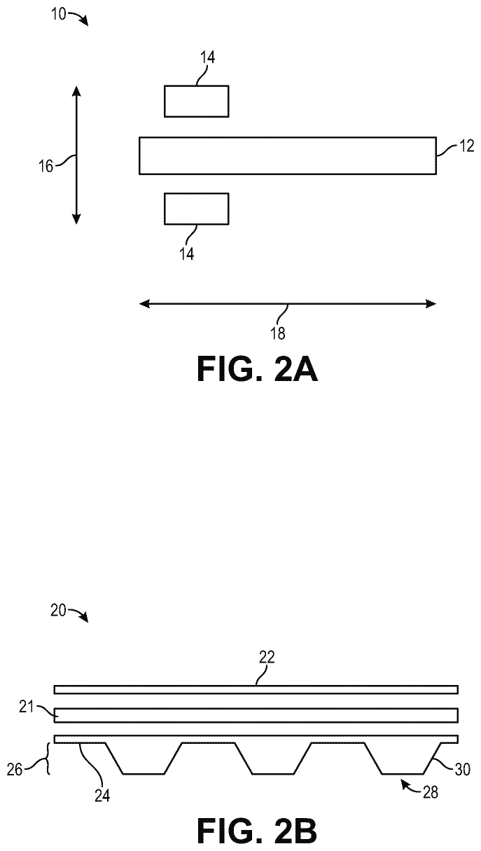

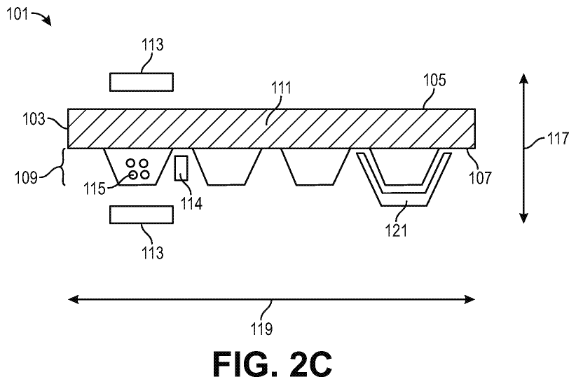

FIG. 2A is an illustration of a magnetofluidic device 10 for assaying a biomolecule from a sample according to an embodiment of the present disclosure. The magnetofluidic device of FIG. 2A includes a cartridge assembly 12 structured to accept and secure a magnetofluidic cartridge to be processed and a magnetic particle manipulation assembly 14 arranged proximate the cartridge assembly. The magnetic particle manipulation assembly includes a pair of magnets 14 arranged to be on opposing sides of the magnetofluidic cartridge and substantially aligned along a line 16 that will be transverse to the magnetofluidic cartridge such that the line can be aligned with a well in the magnetofluidic cartridge. In such an embodiment, the pair of magnets 14 are at least one of moveable along the line 16, or a strength of said pair of magnets is adjustable such that a plurality of magnetic particles when contained within the well can be drawn out of and back into the well during operation. In some embodiments, the magnetic particle manipulation assembly 14 is further structured to provide manipulation of the plurality of magnetic particles, after being drawn out of the well, along a second degree of freedom 18 so as to be able to move the plurality of magnetic particles from the well to a second well in the magnetofluidic cartridge.

FIG. 2B is an illustration showing a magnetofluidic cartridge 20 for assaying a biomolecule from a sample according to an embodiment of the present disclosure. The magnetofluidic cartridge of FIG. 2B includes: a top layer 22, a spacer layer 21, and a bottom layer 24 spaced apart from the top layer 22 in a generally parallel orientation with respect to the top layer 22. The bottom layer 24 defines a plurality of wells 26 therein that protrude from a surface of the bottom layer. In such an embodiment, at least one of the plurality of wells 28 has a wall 30 sufficiently thin to facilitate heat transfer such that a nucleic acid amplification assay is completed in under 20 minutes.

FIG. 2C is an illustration of a magnetofluidic device according to an embodiment of the present disclosure. The magnetofluidic device 101 of FIG. 2C includes a magnetofluidic cartridge 103 to be processed contained within a cartridge assembly (not shown) structured to accept and secure a magnetofluidic cartridge to be processed, the magnetofluidic cartridge as described herein having a top layer 105, a bottom layer 107 spaced apart from the top layer in a generally parallel orientation with respect to the top layer, the bottom layer defining a plurality of wells 109 therein that protrude from a surface of the bottom layer; and a spacer layer 111 between and in contact with the top and bottom layers at least along a periphery thereof to seal contents within the magnetofluidic cartridge. The magnetofluidic device also includes a magnetic particle manipulation assembly 113 arranged proximate to the cartridge assembly, the magnetic particle manipulation assembly being structured to provide manipulation of magnetic particles 115 contained within the magnetofluidic cartridge along a first degree of freedom 117 so as to be able to draw magnetic particles into and out of each of the plurality of wells, wherein the magnetic particle manipulation assembly is further structured to provide manipulation of magnetic particles contained within the magnetofluidic cartridge along a second degree of freedom 119 so as to be able to move magnetic particles from one of the plurality of wells to another one of the plurality of wells. The magnetic particle manipulation assembly includes a pair of magnets 113 arranged to be on opposing sides of the magnetofluidic cartridge with one of the plurality of wells therebetween. The magnetofluidic device also includes a temperature control assembly 121 being configured to receive at least one of the plurality of wells. The magnetofluidic device also includes a temperature modulation assembly 114 arranged proximate to the cartridge assembly, which temperature modulation assembly comprises at least one heat source that selectively thermally communicates with one or more of the plurality of wells and/or the channel of the magnetofluidic cartridge, for example, to selectively melt temperature sensitive materials disposed between wells.

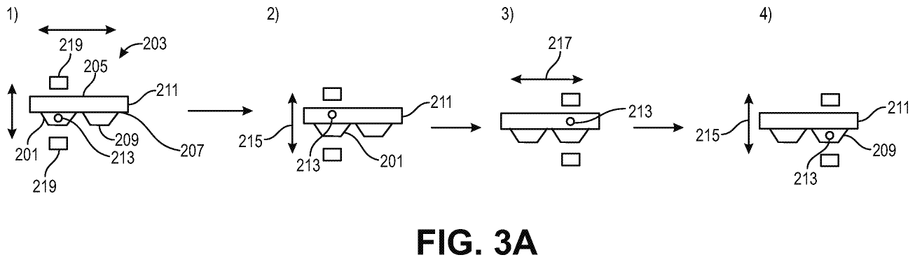

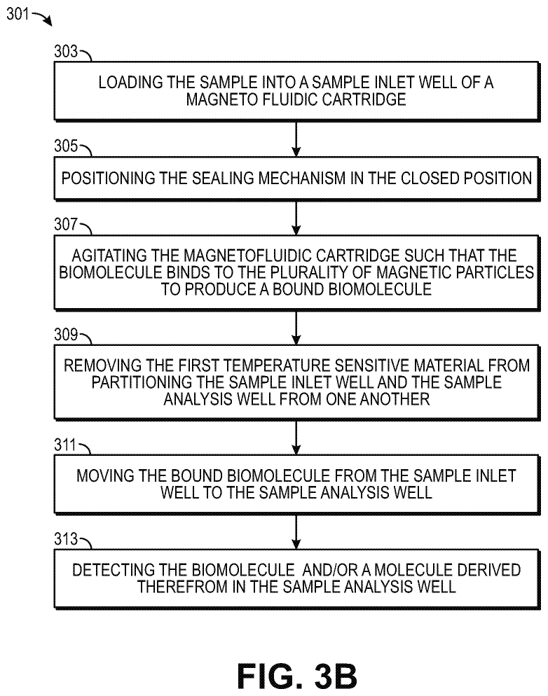

FIG. 3A is a schematic showing a method of detecting a nucleic acid sequence of a nucleic acid molecule in a sample, including the steps of: loading the sample into a sample well 201 of a magnetofluidic cartridge 203 so as to contact the nucleic acid molecule with a magnetic particle 213 such that the nucleic acid molecule binds to the magnetic particle 213 and melting temperature sensitive material (not shown) (step 1); manipulating the magnetic particle 213 bound to the nucleic acid molecule along a first degree of freedom 215 so as to be able to draw the magnetic particle bound to the nucleic acid molecule out of the sample well 201 and into a spacer layer 211 of the magnetofluidic cartridge (step 2); manipulating the magnetic particle 213 bound to the nucleic acid molecule along a second degree of freedom 217 so as to be able translocate the magnetic particle bound to the nucleic acid molecule within the spacer layer to a position above a detection well of the magnetofluidic cartridge (step 3); manipulating the magnetic particle 213 bound to the nucleic acid molecule along the first degree of freedom 215 so as to be able to draw the magnetic particle bound to the nucleic acid molecule out of spacer layer 211 and into the detection well 209 (step 4). The method also includes heating the nucleic acid molecule such that amplification of the nucleic acid sequence occurs; and detecting the nucleic acid sequence. In such an embodiment, manipulation of the magnetic particle bound to the nucleic acid along a first degree of freedom and manipulation of the magnetic particle bound to the nucleic acid along a second degree of freedom includes the use of a pair of magnets 219 arranged to be on opposing sides of the magnetofluidic cartridge with the sample well and the detection well therebetween,

FIG. 3B is a flow chart that schematically shows exemplary method steps of detecting biomolecules in a sample according to some aspects disclosed herein. As shown, method 301 includes loading the sample into a sample inlet well of a magnetofluidic cartridge (step 303) and positioning the sealing mechanism in the closed position (step 305). Method 301 also includes agitating the magnetofluidic cartridge such that the biomolecule binds to the plurality of magnetic particles to produce a bound biomolecule (step 307) and removing the first temperature sensitive material from partitioning the sample inlet well and the sample analysis well from one another (step 309). Additionally, method 301 also includes moving the bound biomolecule from the sample inlet well to the sample analysis well (step 311) and detecting the biomolecule and/or a molecule derived therefrom (e.g., an amplicon or the Ike) in the sample analysis well (step 313).

An embodiment of the present disclosure relates to a magnetofluidic device for assaying a nucleic acid or other biomolecule from a sample, the device having: a cartridge assembly structured to accept and secure a magnetofluidic cartridge to be used for the assaying; and a magnetic particle manipulation assembly arranged proximate the cartridge assembly, the magnetic particle manipulation assembly having a pair of magnets arranged to be on opposing sides of the magnetofluidic cartridge and which are substantially aligned along a line that will be transverse to the magnetofluidic cartridge such that the line can be aligned with a well in the magnetofluidic cartridge. The pair of magnets are at least one of moveable along the line relative to the magnetofluidic cartridge, or a strength of the pair of magnets is adjustable such that a plurality of magnetic particles when contained within the well can be drawn out of and back into the well during operation.

An embodiment of the present disclosure relates to the magnetofluidic device as described herein, where the magnetic particle manipulation assembly is further structured to provide manipulation of the plurality of magnetic particles, after being drawn out of the well, along a second degree of freedom so as to be able to move the plurality of magnetic particles from the well to a second well in the magnetofluidic cartridge.

An embodiment of the present disclosure relates to the magnetofluidic device as described herein, further having a temperature control assembly arranged proximate the cartridge assembly, the temperature control assembly having a heat exchange portion structured and arranged to be in thermal connection with at least one well in the magnetofluidic cartridge.

An embodiment of the present disclosure relates to the magnetofluidic device as described herein, where the heat exchange portion is a heat block that has a shape that is at least partially complementary to a shape of the at least one well to provide an enhanced surface for heat exchange therethrough, and where the temperature control assembly further includes: a heater in thermal contact with the heat block; a temperature sensor in thermal contact with the heat block; a cooling system in thermal contact with the heat block; and a temperature control device configured to receive temperature signals from the temperature sensor and to provide control signals to the heater and the cooling system.

An embodiment of the present disclosure relates to the magnetofluidic device as described herein, where the magnetic particle manipulation assembly further includes: a first actuator assembly operatively connected to the pair of magnets such that the pair of magnets can be moved in unison, back and forth along the line, and a second actuator assembly operatively connected to the pair of permanent magnets such that the pair of permanent magnets can be moved in unison from a location of the well to a location of a second well. The pair of magnets is a pair of permanent magnets.

An embodiment of the present disclosure relates to the magnetofluidic device as described herein, where the second actuator assembly is a rotational assembly, the second degree of freedom being a rotational degree of freedom. An embodiment of the present disclosure relates to the magnetofluidic device as described herein, where the pair of magnets is a pair of electromagnets configured to provide an electronically adjustable magnetic field therebetween. An embodiment of the present disclosure relates to the magnetofluidic device as described herein, further including a detection system arranged proximate the cartridge assembly so as to be able to detect a physical parameter for a test concerning the biomolecule.

An embodiment of the present disclosure relates to the magnetofluidic device as described herein, further including a temperature control assembly arranged proximate the cartridge assembly, the temperature control assembly having a heat exchange portion structured and arranged to be in thermal connection with at least one well in the magnetofluidic cartridge. An embodiment of the present disclosure relates to the magnetofluidic device as described herein, where the detection system includes: an optical source arranged to illuminate a sample well to excite fluorescent molecules therein, and an optical detector arranged to detect fluorescence emissions from the sample well. An embodiment of the present disclosure relates to the magnetofluidic device as described herein, where the detection system includes a confocal epifluorescence detector. An embodiment of the present disclosure relates to the magnetofluidic device as described herein, where the magnetofluidic device is a portable device. An embodiment of the present disclosure relates to the magnetofluidic device as described herein, where the magnetofluidic device is a handheld device.

An embodiment of the present disclosure relates to a magnetofluidic cartridge for assaying a nucleic acid sequence or other biomolecule from a sample, the cartridge including: a top layer; and a bottom layer spaced apart from the top layer in a generally parallel orientation with respect to the top layer, the bottom layer defining a plurality of wells therein that protrude from a surface of the bottom layer. The at least one of the plurality of wells having a wall sufficiently thin to allow a heat transfer rate such that a nucleic acid amplification assay can be completed in under 20 minutes. An embodiment of the present disclosure relates to the magnetofluidic cartridge as described herein, where one of the plurality of wells has a wall of between 0.05-0.5 mm in thickness. An embodiment of the present disclosure relates to the magnetofluidic cartridge as described herein, further including a spacer layer between and in contact with the top and bottom layers at least along a periphery thereof to seal contents within the magnetofluidic cartridge.

An embodiment of the present disclosure relates to the magnetofluidic cartridge above, where further including a plurality of magnetic particles preloaded into at least one of the plurality of wells, where the at least one of the plurality of wells is a sample well having a port for disposing a sample therein during use, and where the plurality of magnetic particles are coated magnetic nanoparticles that are coated so as to adhere to nucleic acids or other biomolecules via electrostatic or intermolecular forces. An embodiment of the present disclosure relates to the magnetofluidic cartridge above, further having: a plurality of processing fluids each preloaded in a respective one of the plurality of wells; and a sealing fluid preloaded into the magnetofluidic cartridge between the top and bottom layers. The sealing fluid is immiscible with the plurality of processing fluids so as to provide containment of each of the plurality of processing fluids in a respective one of the plurality of wells, and the sealing fluid is hydrophobic.

An embodiment of the present disclosure relates to the magnetofluidic cartridge as described herein, where each of the plurality of processing fluids preloaded into the magnetofluidic cartridge are selected in number and type according to the test to be performed. An embodiment of the present disclosure relates to the magnetofluidic cartridge as described herein, where at least one of the plurality of processing fluids includes a reagent for a nucleic acid amplification assay. An embodiment of the present disclosure relates to the magnetofluidic cartridge as described herein, where the magnetofluidic cartridge is self-contained and remains sealed other than to receive a sample during an entirety of the nucleic acid amplification assay.

An embodiment of the present disclosure relates to a method of detecting a biomolecule in a sample, including: loading the sample into a sample well of a magnetofluidic cartridge so as to contact the biomolecule with a magnetic particle such that the biomolecule binds to the magnetic particle; manipulating the magnetic particle bound to the biomolecule along a first degree of freedom so as to be able to draw the magnetic particle bound to the biomolecule out of the sample well and into a spacer layer of said magnetofluidic cartridge; manipulating the magnetic particle bound to the biomolecule along a second degree of freedom so as to be able translocate the magnetic particle bound to the biomolecule within the spacer layer to a position above a detection well of the magnetofluidic cartridge; manipulating the magnetic particle bound to the biomolecule along the first degree of freedom so as to be able to draw the magnetic particle bound to the biomolecule out of spacer layer and into the detection well; heating the biomolecule such that amplification of the biomolecule occurs; and detecting the biomolecule.

An embodiment of the present disclosure relates to a method as described herein, where the manipulating the magnetic particle bound to the biomolecule along a first degree of freedom and the manipulating the magnetic particle bound to the biomolecule along a second degree of freedom includes the use of a pair of magnets arranged to be on opposing sides of said magnetofluidic cartridge with the sample well and said detection well therebetween. An embodiment of the present disclosure relates to the method as described herein, where amplifying the biomolecule includes the use of a temperature control assembly arranged proximate the cartridge assembly and being structured to receive the detection well in a heat exchange portion of the temperature control assembly. An embodiment of the present disclosure relates to the method as described herein, where heating the biomolecule includes heating the biomolecule such that amplification of the biomolecule occurs in under 20 minutes.

An embodiment of the present disclosure relates to a method of detecting a nucleic acid sequence of a nucleic acid molecule in a sample, including: loading the sample into a sample well of a magnetofluidic cartridge so as to contact the nucleic acid molecule with a magnetic particle such that the nucleic acid molecule binds to the magnetic particle; manipulating the magnetic particle bound to the nucleic acid molecule along a first degree of freedom so as to be able to draw the magnetic particle bound to the nucleic acid molecule out of the sample well and into a spacer layer of the magnetofluidic cartridge; manipulating the magnetic particle bound to the nucleic acid molecule along a second degree of freedom so as to be able translocate the magnetic particle bound to the nucleic acid molecule within the spacer layer to a position above a detection well of the magnetofluidic cartridge; manipulating the magnetic particle bound to the nucleic acid molecule along the first degree of freedom so as to be able to draw the magnetic particle bound to the nucleic acid molecule out of spacer layer and into the detection well; heating the nucleic acid molecule such that amplification of the nucleic acid sequence occurs; and detecting the nucleic acid sequence.

An embodiment of the present disclosure relates to the method of detecting a nucleic acid sequence of a nucleic acid molecule in a sample as described herein, where the manipulating the magnetic particle bound to the nucleic acid molecule along a first degree of freedom and the manipulating the magnetic particle bound to the nucleic acid molecule along a second degree of freedom includes the use of a pair of magnets arranged to be on opposing sides of the magnetofluidic cartridge with the sample well and the detection well therebetween. An embodiment of the present disclosure relates to the method of detecting a nucleic acid sequence of a nucleic acid molecule in a sample as described herein; where the amplifying the nucleic acid sequence includes the use of a temperature control assembly arranged proximate the cartridge assembly and being structured to receive the detection well in a heat exchange portion of the temperature control assembly. An embodiment of the present disclosure relates to the method of detecting a nucleic acid sequence of a nucleic acid molecule in a sample as described herein, where the heating the nucleic acid includes heating the nucleic acid such that amplification of the nucleic acid occurs in under 20 minutes.

An embodiment of the present disclosure relates to a method of assembling a magnetofluidic cartridge including: forming a first layer defining a plurality of wells therein that protrude from a surface of the bottom layer; forming a second layer defining an inlet for injection of a sample into one of the plurality of wells; and sealing the first layer to the second layer such that the first layer and the second layer are configured to reserve a space located between the first layer and the second layer. Forming the first layer includes heating and molding a first film, forming the second layer includes laser cutting a second film. At least one of the plurality of wells includes a wall sufficiently thin to allow a heat transfer rate such that a nucleic acid amplification assay can be completed in under 20 minutes.

An embodiment of the present disclosure relates to the method of assembling a magnetofluidic cartridge as described herein, further including loading a plurality of magnetic particles into at least one of the plurality of wells prior to sealing the first layer to the second layer. An embodiment of the present disclosure relates to the method of assembling a magnetofluidic cartridge as described herein, further including loading at least one fluid into each of the plurality of wells prior to sealing the first layer to the second layer. An embodiment of the present disclosure relates to the method of assembling a magnetofluidic cartridge as described herein, further including loading a sealing fluid between the first layer and the second layer prior to sealing the first layer to the second layer.

An embodiment of the present disclosure relates to the method of assembling a magnetofluidic cartridge as described herein, where the first layer includes polymethylmethacrylate (PMMA), polypropylene (PP), polyethylene terephthalate (PET), polyethylene terephthalate glycol (PETE), high density polyethylene (HDPE), polytetrafluoroethylene (PTFE), and/or polycarbonate (PC). An embodiment of the present disclosure relates to the method of assembling a magnetofluidic cartridge as described herein, where the second layer includes polymethylmethacrylate (PMMA), polypropylene (PP), polyethylene terephthalate (PET), polyethylene terephthalate glycol (PETG), high density polyethylene (HDPE), polytetrafluoroethylene (PTFE), and/or polycarbonate (PC).

An embodiment of the present disclosure relates to the method of assembling a magnetofluidic cartridge as described herein, where the first layer is between 1.00-8.00 mm in thickness. An embodiment of the present disclosure relates to the method of assembling a magnetofluidic cartridge as described herein, where the second layer is between 0.05-3 mm in thickness. An embodiment of the present disclosure relates to the method of assembling a magnetofluidic cartridge as described herein, where the sealing fluid includes oil, air and wax. An embodiment of the present disclosure relates to the method of assembling a magnetofluidic cartridge as described herein, further including passivating a surface of the plurality of wells prior to sealing the first layer to the second layer.

Some embodiments of the present disclosure are directed to a method for the design and fabrication of a consumable device for use in magnetic particle-driven biochemical assays. Some embodiments of the present disclosure can improve substantially on previously disclosed technology (U.S. Pat. No. 9,463,461) by enabling biochemical processes which require thermal control, e.g. Polymerase Chain Reaction (PCR) or High Resolution Melting Analysis (HRMA), Some aspects of the present disclosure can include, but are not limited to, the following features:

A device comprising 1) a planar hydrophobic substrate for particle transport and 2) a substrate with one or more extruded space for retention and isolation of one or more biochemical reagents; where the said extruded space includes a thin-walled feature (<0.75 mm in thickness) in relation to the exterior of the device; where the biochemical reagents isolated within the confines of the said extruded space, sharing an interface with a common phase (e.g. air, oil); where the common phase is in contact with each reagents as well as a planar hydrophobic substrate.

A method of particle transport, where one or more magnetic particles are manipulated in two dimensions. The first dimension is defined by the extent of transverse motion of magnetic particles between the innermost part of the extruded feature and the planar hydrophobic substrate. The second dimension is defined by the extent of longitudinal motion of magnetic particles along the planar hydrophobic substrate. Particle extraction, translocation and re-suspension facilitated by magnetic actuation in a combination of the two dimensions, where a two-axis mechanical manipulator is an embodiment.

A method of modulating temperature contained within one or more extruded features to facilitate a biochemical process. An example of such a biochemical process may include but is not limited to PCR, Loop Mediated Isothermal Amplification (LAMP), Helicase Dependent Assay (HDA), Rolling Circle Amplification Assay (RCA), Recombinase Polymerase Amplification (RPA), Reverse-Transcription Polymerase Chain reaction (RT-PCR), Specific High-Sensitivity Enzymatic Reporter UnLOCKing (SHERLOCK), DNA endonuclease-targeted CRISPR trans reporter (DETECTR), bacterial culture and HRMA. An example of temperature modulation may include but is not limited to contact heating, radiative heating and photothermal heating.

FIGS. 2A-C and 3 provide schematic illustrations of devices and methods of using the devices according to some embodiments of the present disclosure. A magnetofluidic device for testing biological samples according to an embodiment of the present disclosure includes a cartridge assembly structured to accept and secure a magnetofluidic cartridge to be processed, the magnetofluidic cartridge has a plurality of wells including at least a sample well and a detection well each of which protrudes beyond a surface of the magnetofluidic cartridge; and a magnetic particle manipulation assembly arranged proximate the cartridge assembly, the magnetic particle manipulation assembly being structured to provide manipulation of magnetic particles contained within the magnetofluidic cartridge along a first degree of freedom so as to be able to draw magnetic particles into and out of each of the plurality of wells. The magnetic particle manipulation assembly is further structured to provide manipulation of magnetic particles contained within the magnetofluidic cartridge along a second degree of freedom so as to be able to move magnetic particles from one of the plurality of wells to another one of the plurality of wells.

The magnetofluidic device can further include a detection system arranged proximate the cartridge assembly so as to be able to detect a physical parameter for a test concerning a genetic sample. The magnetofluidic device can further include a temperature control assembly arranged proximate the cartridge assembly that is also structured to receive at least the detection well in a heat exchange portion of the temperature control assembly. In some embodiments, the temperature control assembly includes a heat block defining the heat exchange portion therein for receiving the sample well, a heater in thermal contact with the heat block, a temperature sensor in thermal contact with the heat block, a cooling system in thermal contact with the heat block, and a temperature control device configured to receive temperature signals from the temperature sensor and to provide control signals to the heater and the cooling system.

In some embodiments, the magnetic particle manipulation assembly includes a pair of permanent magnets arranged to be on opposing sides of the magnetofluidic cartridge with one of the plurality of weds therebetween, a first actuator assembly operatively connected to the pair of permanent magnets such that the pair of permanent magnets can be moved in unison, back and forth along an axis to move magnetic particles into and out of one of the plurality of wells, and a second actuator assembly operatively connected to the pair of permanent magnets such that the pair of permanent magnets can be moved in unison from a location of one of the plurality of wells therebetween to a location with a second one of the plurality of wells therebetween. In some embodiments, the second actuator assembly is a rotational assembly such that the second degree of freedom is a rotational degree of freedom.

In some embodiments, the detection system includes an optical source arranged to illuminate the sample well to excite fluorescent molecules therein, and an optical detector arranged to detect fluorescence emissions from the sample well. In some embodiments, the detection system is or includes a confocal epifluorescence detector. In some embodiments, the magnetofluidic device is a portable device. In some embodiments, the magnetofluidic device is a handheld device.

In some embodiments, a magnetofluidic cartridge for a magnetofluidic device for testing genetic samples includes a top layer; a bottom layer spaced apart from the top layer in a generally parallel orientation with respect to the top layer; and a spacer layer between and in contact with the top and bottom layers at least along a periphery thereof to seal contents within the magnetofluidic cartridge. The bottom layer defines a plurality of wells therein that protrude from a surface of the bottom layer.

In some embodiments, the magnetofluidic cartridge can further include a plurality of processing fluids or in lyophilized forms each preloaded in a respective one of the plurality of wells; and a sealing fluid preloaded into the magnetofluidic cartridge between the top and bottom layers. The sealing fluid is immiscible with the plurality of processing fluids so as to provide containment of each of the plurality of processing fluids in a respective one of the plurality of wells. In some embodiments, the magnetofluidic cartridge can further include magnetic particles preloaded into at least one of the plurality of wells. This can be a sample well having a port for disposing a sample therein during use. The magnetic particles can be coated magnetic nanoparticles that adhere electrostatically to genetic material. Each of the plurality of processing fluids can be preloaded into the magnetofluidic cartridge and can be selected in number and type according to the test to be performed.

In some embodiments, the magnetofluidic cartridge has a plurality of wells where at least one of the wells has a thin wall to allow for rapid and efficient temperature control during a nucleic acid amplification assay. This allows for the nucleic acid assay to proceed in under 30, 25, 20, 15, 10, or 5 minutes.

In some embodiments, the magnetofluidic device includes a magnetic particle manipulation assembly having a pair of permanent magnets arranged to be on opposing sides of a magnetofluidic cartridge with one of a plurality of wells therebetween. The magnetic particle manipulation assembly has a first actuator assembly operatively connected to the pair of permanent magnets such that the pair of permanent magnets can be moved in unison, back and forth along an axis to move magnetic particles into and out of the one of the plurality of wells, and a second actuator assembly operatively connected to the pair of permanent magnets such that the pair of permanent magnets can be moved in unison from a location of the one of the plurality of wells therebetween to a location with a second one of the plurality of wells therebetween. Such a conformation allows the device to be used with a variety of cartridges having a variety of shaped wells. Also, such a conformation allows for the transport of a magnetic particle bound to a nucleic acid sample from a first aqueous solution in a first well, through a hydrophobic solution, and then into a second aqueous solution in a second well. Such a process allows for the removal of excess solution from the first well prior to entry into the second well.

In some embodiments, the magnetofluidic device is hand held and allows for the extraction of nucleic acids from a sample, the amplification of these nucleic acids, and their subsequent detection on a single platform.

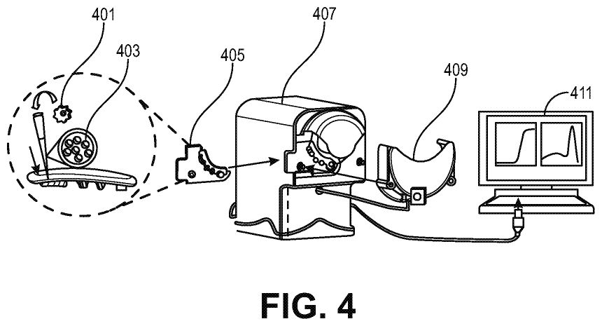

To further illustrate, FIG. 4 schematically shows a magnetofluidic device from a perspective view according to one exemplary embodiment. As shown, the magnetofluidic device includes housing 407 (e.g., a 3D printed housing) that includes a device as described herein. The device includes cartridge assembly 405 structured to accept and secure a magnetofluidic cartridge as described herein (e.g., into which blood serum 401 and magnetic beads 403 are introduced). The magnetofluidic device also includes PCR thermal control faceplate 409 in this exemplary embodiment. As additionally shown, the magnetofluidic device also communicates (e.g., via a wired or wireless connection) to computer 411 for data analysis.

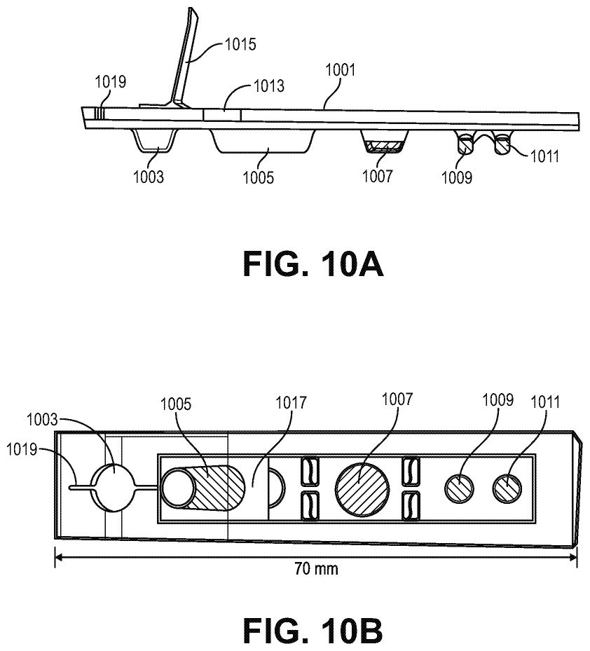

As another exemplary illustration, FIGS. 10A and B schematically show a magnetofluidic cartridge from side and top views, respectively, according to one exemplary embodiment. As shown, the magnetofluidic cartridge includes body structure 1001 that defines a channel and a plurality of wells (overflow reservoir 1003, sample inlet well 1005, wash buffer well 1007, 1^{st} PCR well 1009, and 2^{nd} PCR well 1011) disposed substantially within body structure 1001 that fluidly communicate with one another. In some embodiments, body structures are assembled from multiple separate layers or parts (e.g., two layers or parts, three layers or parts, or the like). In other exemplary embodiments, body structures are fabricated (e.g., molded) as a single integral part. The magnetofluidic cartridge also includes port 1013 disposed through a top surface of body structure 1001 proximal to and in fluid communication with the sample inlet well. The magnetofluidic cartridge also includes sealing mechanism 1015 (shown as an adhesive seal) operably connected to the top surface of body structure 1001. Sealing mechanism 1015 seals port 1013 when sealing mechanism 1015 is in a closed position. The magnetofluidic cartridge also includes first temperature sensitive material 1017 (e.g., a wax plug or the like) disposed in a substantially solid state at least partially within sample inlet well 1005 (e.g., within a recessed region fabricated in sample inlet well 1005). First temperature sensitive material 1017 fluidly partitions sample inlet well 1005 from wash buffer well 1007, 1^{st} PCR well 1009, and 2^{nd} PCR well 1011 when first temperature sensitive material 1017 is in the substantially solid state (e.g., prior to being heated). A sealing fluid (e.g., a silicone oil, etc.) is typically disposed in at least a portion of the channel and is immiscible with magnetic particles, processing or other reagents, and samples. As shown, overflow reservoir 1003 is structured to receive excess sample, such as when the sample is received in sample inlet well 1005 through port 1013.

As also shown in FIGS. 10A and B, the magnetofluidic cartridge also includes vent orifice 1019 disposed through a portion of body structure 1001. Vent orifice 1019 fluidly communicates with the channel and is structured to vent gases from the channel when the magnetofluidic cartridge is heated (e.g., to prevent the cartridge from bursting, samples being unintentionally contacted with (e.g., contaminating) other reagents, etc.). In some embodiments, the magnetofluidic cartridge also includes a filter (e.g., a sintered polyethylene filter, a polytetrafluoroethylene (PTFE) membrane, or the like) disposed at least proximal to vent orifice 1019. The filter is structured to substantially prevent leakage of fluidic material from the channel through vent orifice 1019.

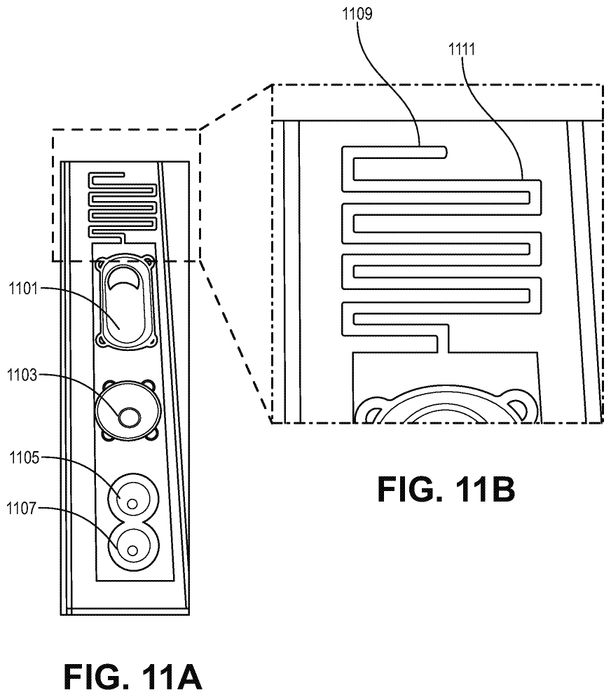

To further illustrate, FIGS. 11A and B schematically show a magnetofluidic cartridge having a vent orifice from top and detailed views, respectively, according to one exemplary embodiment. As shown, the magnetofluidic cartridge includes sample inlet well 1101, wash buffer well 1103, 1^{st} PCR well 1105, and 2^{nd} PCR well 1107. As also shown, the magnetofluidic cartridge also includes vent orifice 1109 that fluidly communicates with the wells via vent channel 1111. Vent channel 1111 allows gas to escape from the magnetofluidic cartridge through vent orifice 1109 when pressure and/or heat is applied to melt wax and/or lyse sample components,

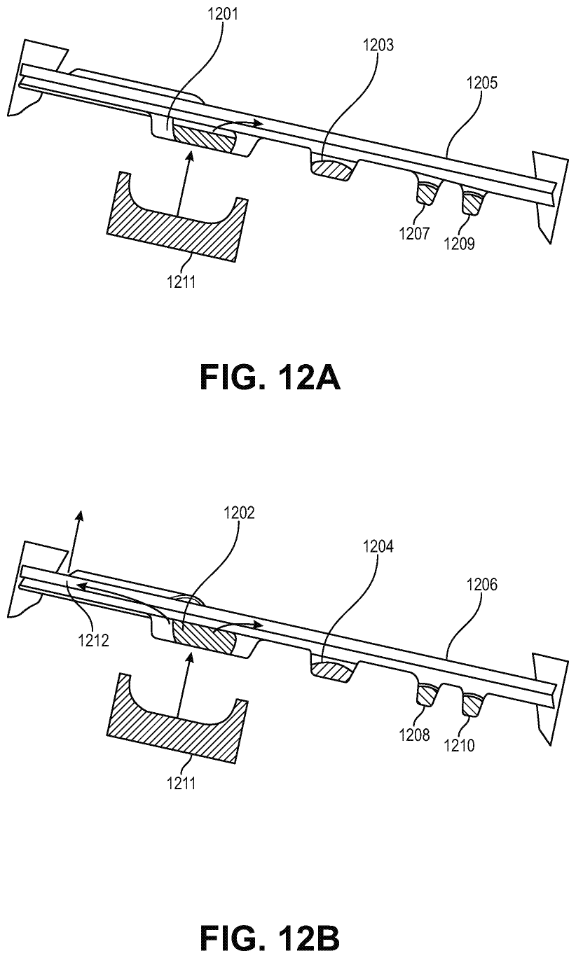

FIG. 12A schematically shows a magnetofluidic cartridge lacking a vent orifice from a side view according to one exemplary embodiment. As shown, the magnetofluidic cartridge includes sample inlet well 1201, wash buffer well 1203, 1^{st} PCR well 1207, and 2^{nd} PCR well 1209 that fluidly communicate with one another via channel 1205, In the absence of a vent orifice, pressure tends to push trapped gas in the magnetofluidic cartridge causing potential sample leakage or unintended contamination down (see the directional arrow) the cartridge into other wells or risks bursting seals between portions of the cartridge body structure, for example, when temperature modulation assembly 1211 applies heat to the magnetofluidic cartridge. In contrast, FIG. 12B schematically shows a magnetofluidic cartridge having a vent orifice from a side view according to one exemplary embodiment. As shown, the magnetofluidic cartridge includes sample inlet well 1202, wash buffer well 1204, 1^{st} PCR well 1208, and 2^{nd} PCR well 1210 that fluidly communicate with one another via channel 1206. In addition, the magnetofluidic cartridge also includes vent orifice 1212 in fluid communication with the wells. In this embodiment, when temperature modulation assembly 1211 applies heat to the magnetofluidic cartridge, excess gas is allowed to escape the cartridge via vent orifice 1212 (see the directional arrows), thereby preventing potential contamination and/or cartridge failure. As also shown in FIGS. 12A and B, the magnetofluidic cartridges and temperature modulation assembly 1211 are positioned in a tilted orientation, which allows for less dense wax to rise and evacuate the channel for magnetic particle transfer between the wells.

### EXAMPLES

### Example 1: Methods for Reagent Storage and Stabilization within an Automated Assay Scaffold

Methods

1. Assay Cartridge with Wax Seal for Reagent Immobilization

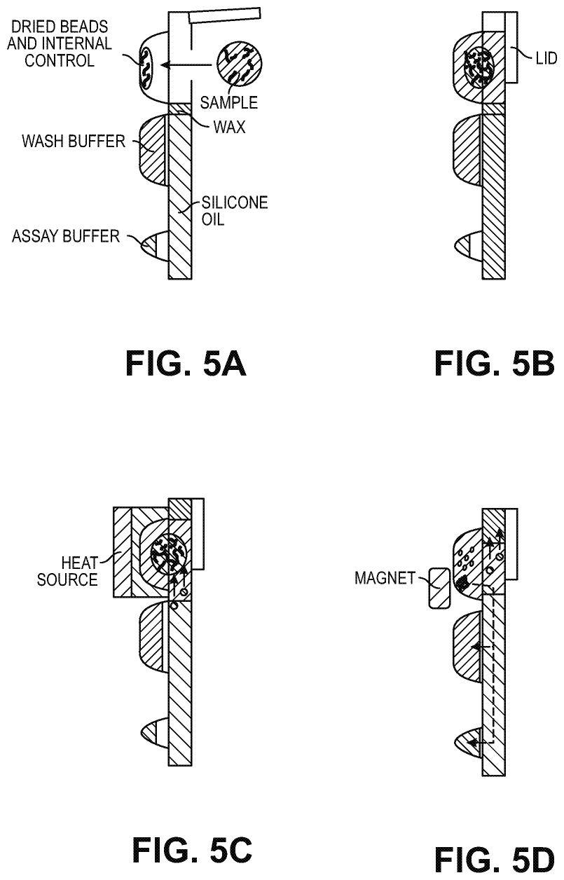

The assay cartridges include a multitude of wells for (i) storage of magnetic beads and sample processing buffers and/or internal assay controls mixed upon injection of sample material, (ii) buffer employed to wash the magnetic beads with captured analyte in order to remove compounds that may inhibit the assay, and (iii) assay reagents which produce a measurable signal change upon introduction of the target (FIG. 5a). A layer of oil provides an immiscible barrier to restrain aqueous reagents within their wells. The initial well used for introduction of the sample is isolated from the oil and remainder of reagents with a wax plug. After introduction of the sample into the cartridge, the cartridge inlet port is closed to prevent leakage of the sample and the cartridge may be shaken to distribute the sample with pre-stored magnetic beads and buffers in the first well (FIG. 5b). Application of heat to the first well promotes melting of the wax plug to provide an open channel for magnetic bead transfer into the remainder of the cartridge wells (FIG. 5c-d).

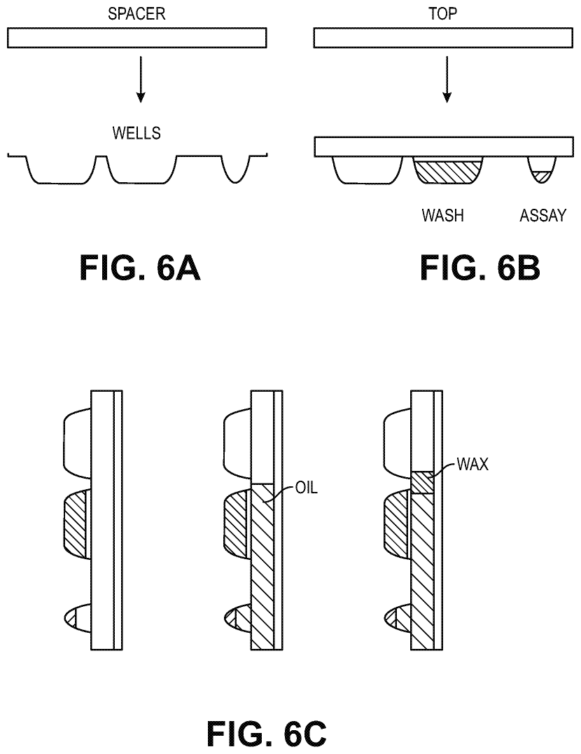

In the following example, a nucleic acid analyte was captured and transferred between wells using magnetic beads functionalized with electronegative charged species (ChargeSwitch, Invitrogen). Binding and release of the nucleic acids was mediated with electrostatic interactions dependent on the pH of the respective buffers. Cartridge wells used for storage of the assay buffers were fabricated using thermoformed polypropylene (PP) or polyethylene terephthalate glycol (PETG) and assembled with laser-cut polymethyl methacrylate (PMMA) “spacer” sections using pressure-sensitive adhesive to form the body of the cartridge (FIG. 6a). Before the cartridge was sealed with a laser-cut “top” layer of PMMA, 10 μL PCR buffer and 50 μL wash buffer (ChargeSwitch, Invitrogen) were dispensed into respective wells (FIG. 6b). The top layer of the cartridge was laminated with polytetrafluoroethylene (PTFE) tape to provide a non-stick surface for magnetic bead transport between wells. With the cartridge top sealed, the remaining space above the assay and wash buffers was filled with silicone oil (50 cSt, Sigma-Aldrich) through the inlet port at the top of the cartridge. Tilting the cartridge towards vertical with the assay well at the bottom allowed the oil to settle over the reagents and any trapped air bubbles to escape before sealing the oil from movement into the first well with 50 μL molten docosane wax (Sigma-Aldrich) (FIG. 6c).

2. Dry Storage of Sample-Processing Reagents

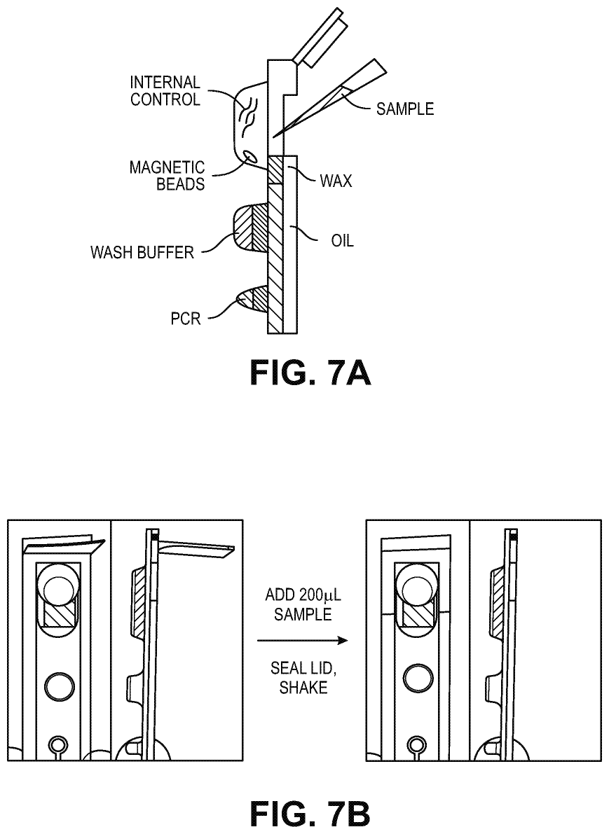

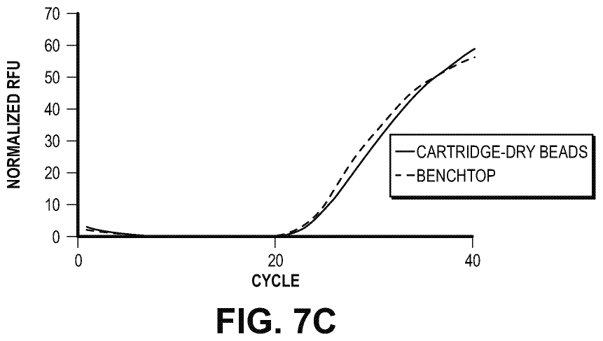

To permit rapid sample preparation for analyte capture, functionalized magnetic particles and all necessary reagents used to process the sample may be dispensed into the first cartridge well in a dried state or dried directly in the cartridge well. To demonstrate this concept for the capture of nucleic acids, 4 μL magnetic beads (25 mg/mL, ChargeSwitch, Invitrogen) were mixed with 10 μL 0.2M ammonium phosphate, 2 μL 10% v/v Tween-20 (Sigma-Aldrich), and 2 μL of 10⁶ copies/μL internal control RNA (Luciferase Control RNA, Promega), and dried under vacuum directly within the first well of a PETG cartridge. The dried reagents were reconstituted with 200 μL water spiked with 10⁵ copies of synthetic SARS-CoV2 RNA target and the cartridge was sealed and shaken (FIG. 7a-b). Robotic actuation of permanent magnets transferred the magnetic beads through 50 μL wash buffer in the second cartridge well followed by elution into the third well containing 10 μL of RT-PCR mix for thermocycling and fluorescence detection.

3. Dry Storage of Temperature-Sensitive Assay Reagents

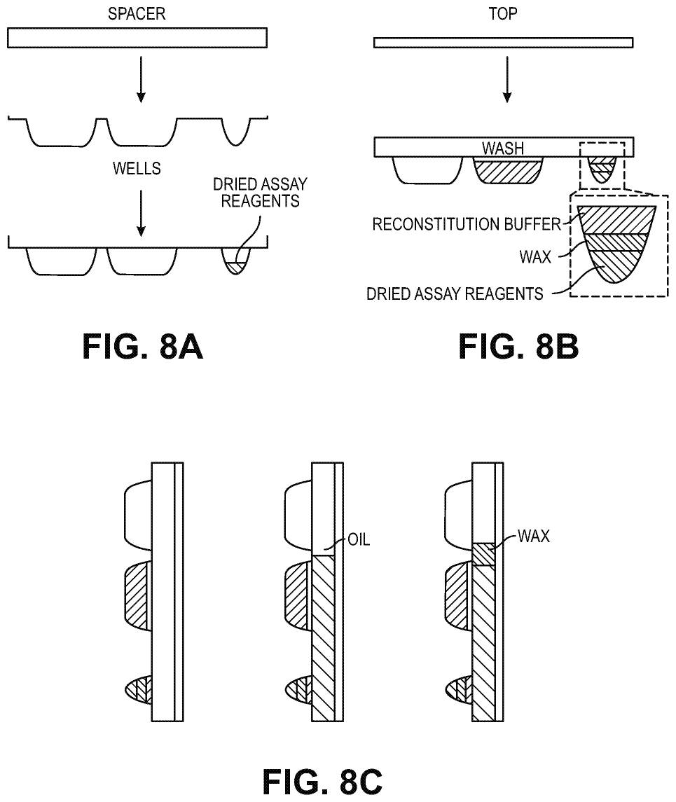

Cartridges were assembled using thermoformed polypropylene wells adhered to laser-cut acrylic spacers using a pressure-sensitive transfer tape. Prior to sealing with the top section, 5.85 μL of PCR buffer was dispensed into the assay well of the cartridge for freezing and lyophilization (FIG. 8a). Once lyophilized, approximately 4 μL of molten docosane wax was dispensed over the dry PCR pellet and 10 μL water was dispensed onto the wax after solidification (FIG. 8b), The second well of the cartridge was filled with 50 μL of wash buffer followed by sealing the cartridge with a laser-cut top layer of acrylic laminated with PTFE tape. Wells were then covered by injecting 420 μL silicone oil into the cartridge.

To activate the PCR assay, the PCR well was subjected to a 100° C. heatblock controlled by a thermoelectric element for 2 minutes, which melted the wax seal to permit reconstitution of the dried PCR reagents. The cartridge was then used for purification and transfer of 1 μL of 1 μM synthetic DNA targets captured on 4 μL 25 mg/mL magnetic beads by mixing with 30 μL binding buffer and injecting into the first well of the cartridge followed by magnetic transfer through the wash buffer and elution into the PCR for thermocycling and fluorescence detection.

4. PCR and RT-PCR Assay Buffers

PCR buffers for synthetic SARS-CoV2 RNA targets (2019-nCoV CDC RUO Plasmid Control, Integrated DNA Technologies) were prepared in 10 μL reaction volumes containing 5 μL 2× Lyo-Ready qPCR Mix (Meridian Life Science), 1 U SpeedSTAR HS DNA polymerase (Takara Bio), 1.5 U WarmStart RTx Reverse transcriptase (New England BioLabs), 2 μM final concentration of forward (5′-GAC CCC AAA ATC AGO GAA AT-3′, IDT (SEQ ID NO: 1)) and reverse primers (5′-TCT GGT TAC TGC CAG TTG AAT CTG-3′, IDT (SEQ ID NO: 2)), and 1 μM final concentration of FAM-tagged hydrolysis probe double-quenched with ZEN and Iowa Black FQ (IABFQ) (5′-FAM-ACC COG CAT-ZEN-TAC GTT TGG TGG ACC-IABFQ-3′, IDT (SEQ ID NO: 3)), Control assays were run on a benchtop thermocycler (CFX96, Bio-Rad) with direct spike of 10⁶ copies of synthetic SARS-CoV2 RNA target.

PCR buffers for synthetic DNA targets (5′-GCA GCC ACT GGT AAC AGG ATC TGA TGT TGA AGG ACG GAT TAT ATC GGG ACT CAC TAT AAC TGT AGG CAC CAT CAA TC-3′ (SEQ ID NO: 4)) were prepared in 5.85 μL reaction volumes containing 5 μL 2× Lyo-Ready qPCR Mix (Meridian Life Science), 1 U SpeedSTAR HS DNA polymerase (Takara Bio), 1.5 U WarmStart RTx Reverse transcriptase (New England BioLabs), 2 μM final concentration of forward (5′-GCA GCC ACT GGT AAC AGG AT-3′, IDT (SEQ ID NO: 5)) and reverse primers (5′-GAT TGA TGG TGC CTA CAG TTA TAG TGA GTC-3′, IDT (SEQ ID NO: 6)), and 1 μM final concentration of Cy5-tagged hydrolysis probe double-quenched with TAO and Iowa Black RQ (IAB) (5′-Cy5-CCG ATA TAA-TAO-TOO GTC OTT CAA CAT CAG-IABRQ-3′, IDT (SEQ ID NO: 7)). The reaction buffer was frozen with the cartridge at −20° C. followed by overnight lyophilization and wax-coating the following day. Control assays was run on a benchtop thermocycler (CFX96, Bio-Rad) with the reaction volume raised to 10 μL with the addition of PCR-qualified water and 1 μL of 1 μM synthetic DNA target for the direct spike positive control or solely water for the no-template control (NTC).

All PCR reactions were run for 40 cycles with temperature targets of 5 sec denaturation at 95° C. followed by 20 sec annealing at 60° C.

Results and Discussion

Wax seals implemented in automated assay cartridges provide a stable thermally-labile barrier to provide physical and chemical stability to pre-stored reagents. Using wax provides advantages in overall footprint of the assay device scaffolding compared to sequestering reagents in segmented blister packs as well as reducing the instrumentation complexity needed to open access to reagents. A small heat-source in the form of a thermoelectric element, resistive heater, or light source coupled to light absorbing elements native to or added to the wax can provide cartridge activation without manual intervention, fluidic pumps, or motorized actuators.

Assembly of the assay cartridge with wax seals was achieved by aliquoting molten wax manually by pipette. Alternatively, the wax could be applied by automated dispensing from a heated pipette robot attachment or by addition of a solid sheet or pellet dispensed into the cartridge followed by the application of heat to melt the wax and form a seal over the oil or dried reagents. Similarly, oil and other liquid reagents were dispensed manually in the disclosed experiments though this procedure could be automated by pipetting robot or with connections to precision flow controllers.

Once the wax has melted with the cartridge in an upright position, it floats through the oil to the top of the cartridge. The removal of the wax opens a conduit in the cartridge, which allows for subsequent magnetofluidic transfer of captured analytes through the previously inaccessible reagents. This melted wax can serve as a secondary safeguard in conjunction with the sealed cartridge lid to prevent potentially hazardous sample material or contaminating assay reagents from escaping through the inlet port.

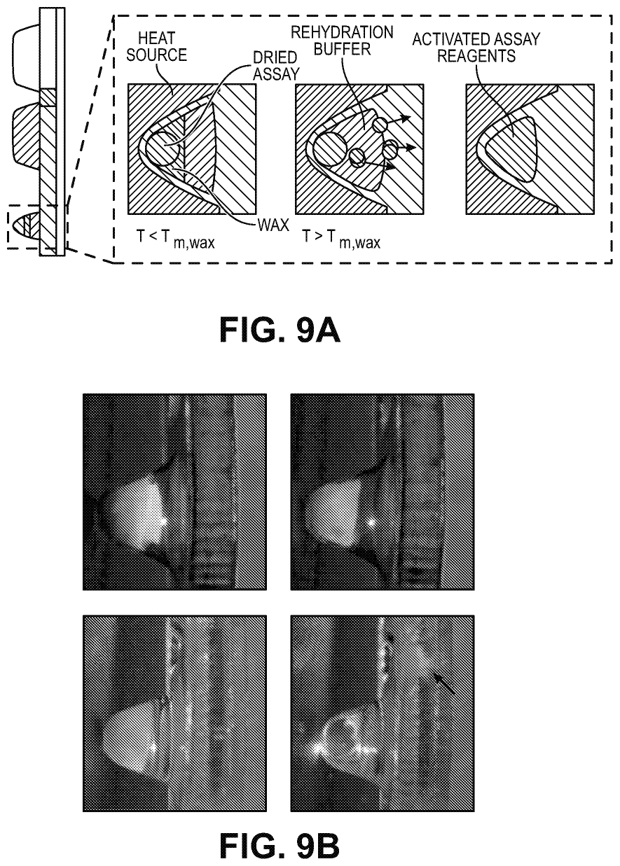

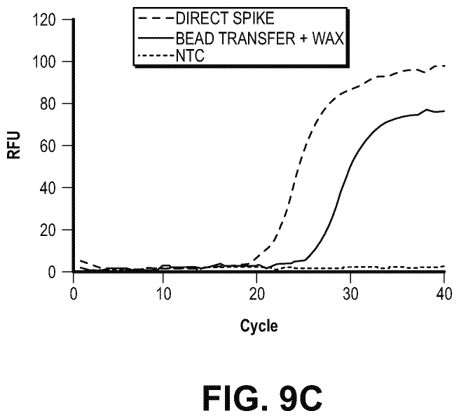

Magnetofluidic cartridges preloaded with assay reagents and sealed with docosane wax were sufficiently stabilized to allow shaking and inversion of the cartridge without displacement or leakage of on-board reagents or loaded sample. This physical stability enables robust assay reagent storage within the cartridge wells during transport and permits the user to agitate the cartridge after sample loading to mix the sample with dried beads and reagents (FIG. 7a-b). This method of reconstituting the dried beads and binding buffers was shown to successfully bind synthetic SARS-CoV-2 RNA within the sample as shown by near identical amplification by RT-PCR on cartridge versus a direct spike benchtop control (FIG. 7c). On-cartridge reconstitution of dried reagents was also demonstrated with pre-loaded aqueous buffer within a cartridge well containing wax-coated lyophilized PCR reagents (FIG. 9a-b). Applying heat to the wax seal caused the molten wax to exit the well, therefore exposing the dried reagents to the rehydrating buffer. Subsequent magnetic transfer of nucleic acid targets into the PCR followed by thermocycling showed the reconstituted PCR retained enzymatic activity for detectable fluorescence of amplified targets (FIG. 9c).

The wax material chosen for sealing should be (i) chemically inert when in contact with the assay components, (ii) minimally soluble in the oil covering the reagents, (iii) lower density than the other reagents to permit buoyant clearance to the top of the cartridge once melted, and (iv) possess a melting temperature higher than the expected ambient conditions and compatible with assay components and cartridge material. Docosane was used for demonstration as a seal for the PCR assays for its chemical compatibility and melting point of around 45° C., which is well above average ambient indoor temperatures and below the deactivation temperatures of enzymes involved in the reaction. Additional waxes including paraffins or other higher alkanes (e.g. tricosane, tetracosane, pentacosane, etc.) with similar chemical properties to docosane could be leveraged for a variety of melting temperatures of wax seals. Melting the wax seals in the above experiments was achieved using application of a machined metal heat block with heat supplied by a thermoelectric element, though heat could alternatively be applied with a resistive heater; heated air directed onto the cartridge, or through exposure to electromagnetic radiation.

### CONCLUSIONS

To enable on-demand testing within an automated cartridge system, the necessary reagents should remain viable throughout transport and exposure to the environment. In this example, a combination of thermally-labile wax seals and dried reagents with pre-stored aqueous buffers enable stable reagent storage on magnetofluidic cartridges. Rapid activation of the cartridges for on-demand use is facilitated by direct injection of sample into the cartridge and administration of heat to the wax seal regions. These methods provide a simple method for conducting sensitive chemical and biological assays with minimal complexity of user interaction or instrumentation.

### Example 2: Magnetofluidic Platform for Rapid Multiplexed Screening of SARS-COV-2 Variants and Other Respiratory Pathogens

### Introduction

The COVID-19 pandemic continues to ripple across the globe. While the expedited development and distribution of vaccines brings hope for a return to normalcy, the concurrent rise of SARS-CoV-2 viral variants—including the highly transmissible variants B.1.1.7 in the United Kingdom, B.1.135 in South Africa, and P.1 in Brazil—threatens increased spread of COVID-19 and potential escape from vaccine protection. There is overwhelming evidence that extensive routine testing is critical to curbing the spread and mounting toll of the virus. However, as these variants with higher rates of transmission have emerged and dominated the spread of COVID-19, insufficient screening and surveillance has left public health officials with large gaps in knowledge of their extent and impact. Diagnostic screening for variants must be made widely accessible to provide effective diagnostics for COVID-19 and notify policy makers if more stringent measures are needed to control the spread.

While genomic sequencing is the primary method for identification of virus variants, the necessary equipment and data processing required to conduct sequencing procedures is prohibitively expensive and complex for universal adoption. Currently in the United States, initiatives like the National SARS-CoV-2 Strain Surveillance (NS3) system has scaled up sequencing to track virus variants, but as of late January 2021, NS3 was capable of sequencing only 750 samples per week. Instead of sequencing, nucleic acid tests (NATs) typically used for diagnosis may be readily modified to detect characteristic sequences of known variants. Although relatively easy to implement compared to sequencing, the increase in demand for NATs during the pandemic has revealed severe deficiencies in public access to infectious disease diagnostics and aggravated existing shortages in testing capacity, supplies, and laboratory personnel. The high demand for NATs will continue after the pandemic, as it is predicted that COVID-19 will become endemic alongside other respiratory viruses. In addition to variant detection, future testing will need to differentiate COVID-19 from influenza viral infections that produce similar symptoms.

The gold standard NATs for detection of SARS-CoV-2 RNA and other respiratory viruses use reverse-transcription polymerase chain reaction (RT-PCR). These tests provide the greatest sensitivity and specificity, but typically require transport to high complexity laboratories in centralized test facilities which can lead to large backlogs with turnaround times of days or weeks. Test results should ideally be delivered on-site at the testing location to facilitate recording of accurate surveillance data and to enable immediate notification of the test results to the patient for initiating quarantine or linkage to care. Currently available rapid NAT platforms typically require trained personnel, may still require upwards of an hour from sample-to answer, or utilize expensive instruments and test cartridges making rapid screening for a large population with these systems unrealistic. Because of the high cost per test of these automated NAT platforms, many strategies for large scale testing opt for cheaper antigen tests. Compared to PCR, these viral antigen tests have reduced sensitivity, higher rates of false-positives, and are not easily amenable to multiplexed detection of several genetic targets or pathogens.

To address the need for affordable and accessible multiplexed NATs with a fast turnaround time, we have developed a Portable, Rapid, On-cartridge, Magnetofluidic, Purification, and Testing (PROMPT) platform. Testing with the PROMPT platform's disposable cartridges enables sample-to-answer RT-PCR in under 30 minutes with detection of up to 4 genetic targets per test. In this work, we have developed two different cartridges—one for SARS-CoV-2 detection and differentiation of its variants, and another for multiplexed screening of SARS-CoV-2 with Influenza A, and Influenza B. Instead of traditional fluidic strategies for sample handling and assay automation, all processes are handled within simple plastic cartridges using the transfer of magnetic beads, which capture, purify, and transfer nucleic acids for amplification and detection. This “magnetofluidic” technology with isolated static assay reagents obviates the need for the precision fluidic channels and flow controllers that increase the complexity and cost of instruments and cartridges on the market.

While previous studies using magnetofluidic cartridges were limited to a single reaction well per cartridge, this example achieves higher levels of multiplexed detection through a combination of duplexed PCR probe assays and a novel multi-elution aliquoting scheme to distribute nucleic acids captured from samples. This magnetofluidic technology presents a potent opportunity to expand access to screening SARS-CoV-2 variants and multiplexed respiratory pathogen testing in any setting with minimal training and immediate on-site reporting of results. We demonstrate the utility of our PROMPT cartridges with assay validation using clinical extracted RNA, nasopharyngeal swab eluates, and saliva samples.

Results

PROMPT Assay Design and Workflow

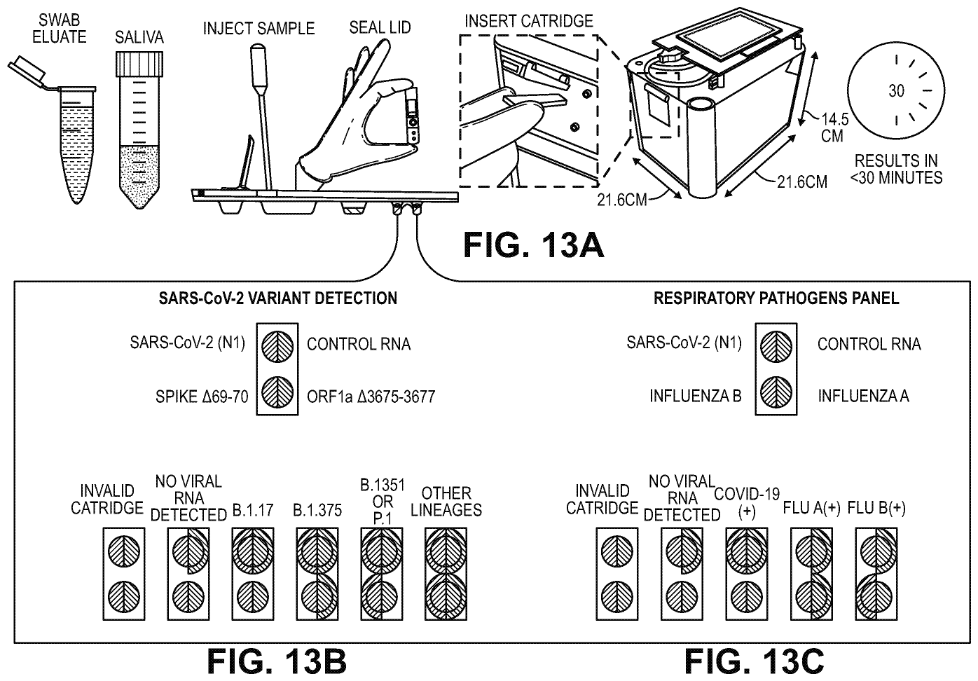

To conduct a test on the PROMPT platform, the sample is first mixed with a buffer containing magnetic beads followed by dispensing the entire mixture into the sample port of the cartridge. Once sealed with an adhesive tab to prevent exposure of infectious samples to the environment, the cartridge is inserted into a slot in the side of the instrument (FIG. 13a). Identifying information for the sample is entered by the user using the instrument's touchscreen interface followed by full automation of nucleic acid extraction, purification, and amplification by RT-PCR. The instrument conducts real-time analysis of fluorescent signals with fully interpreted results displayed on the screen in under 30 minutes. Each instrument has a compact footprint (14.5 cm×21.6 cm×14.5 cm) and built-in wireless connectivity for potential integration with laboratory information systems.

We designed two different cartridge assays (FIG. 13b-c) for either detection and discrimination of SARS-CoV-2 variants of concern, or multiplexed diagnosis of SARS-CoV-2 with Influenza A and B. Both cartridges employ two duplexed PCR assays in separate wells containing hydrolysis probes labelled with FAM or Cy5/TYE fluorophores for a total of 4 target sequences per cartridge. To ensure cartridge reagents are functional and sample processing is fully completed, each cartridge assay detects a synthetic RNA sequence with the control target pre-mixed in the magnetic bead solution. In both cartridges, the conserved N1 target sequence was adopted from the Centers for Diseases Control and Prevention (CDC) assay for use in universal detection of all SARS-CoV-2 variants. Detection of N1 and control RNA are duplexed in the first well in both designs.

The cartridge for discrimination of SARS-CoV-2 variants uses the second PCR well for primers and probes designed by Vogels et al, [Vogels, C. B. F. B. F. et al. PCR assay to enhance global surveillance for SARS-CoV-2 variants of concern. medRxiv 351, 2021.01.28.21250486 (2021).] to detect the presence of distinct mutations in the SARS-CoV-2 spike (Δ69-70) and ORF1a (Δ3675-3677) genes (FIG. 13b), The Δ69-70 mutation is associated uniquely with the B.1.1.7. variant that has shown high transmissibility and spread rapidly throughout Europe. Meanwhile, the ORF1a deletion is found in all previously mentioned variants of concern including B.1351 and P.1. The PCR probes are designed such that all sequences should produce an amplification signal in virus lineages not included within the variants of concern, while signal dropout occurs if the given mutations are present. In the second cartridge design for multiplexed detection of SARS-CoV-2 with influenza A and B, the second PCR well instead contains a duplex assay containing primers and probes for influenza A and B detection (FIG. FIG. 13c).

Magnetofluidic Cartridge Design

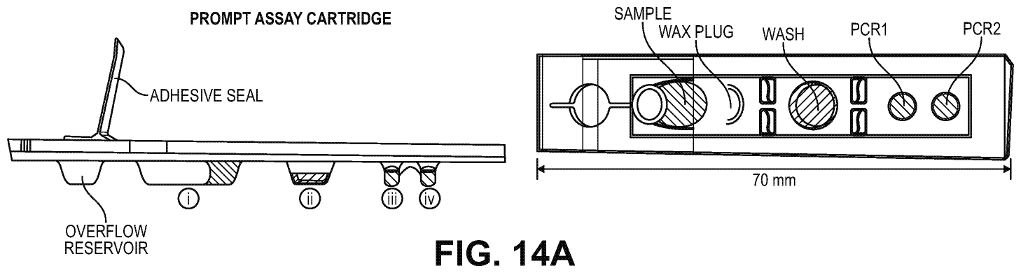

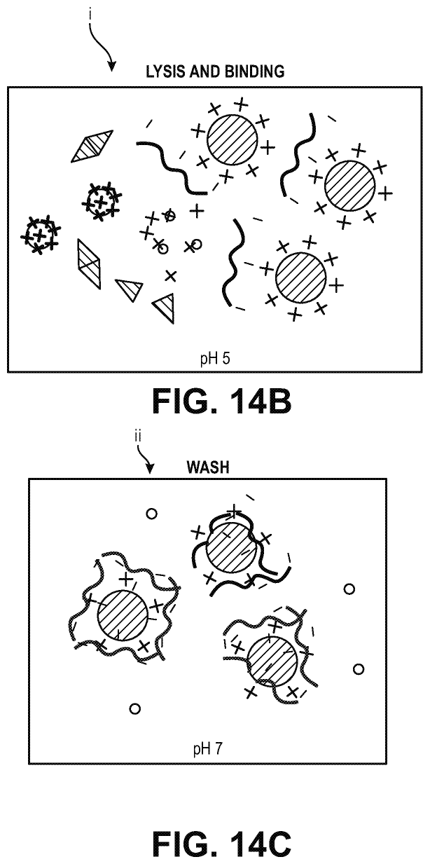

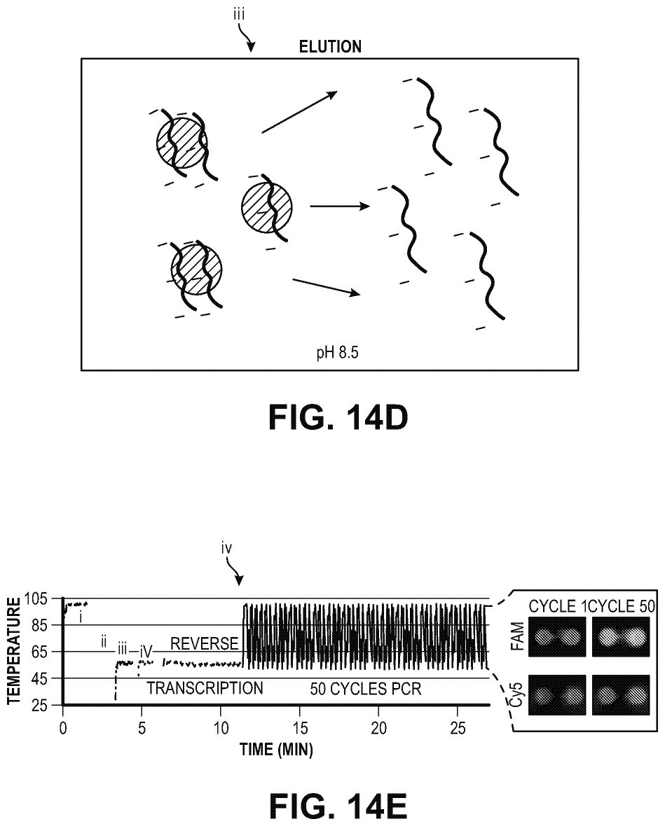

The cartridge design in this work builds upon previous developments of magnetofluidics and magnetofluidic cartridges. Construction of the cartridges use simple lamination techniques of three thermoplastic layers that have been laser-cut and thermoformed. All reagents are pre-loaded into extruded thermoformed wells of the cartridge except for the magnetic beads which are mixed with the sample prior to loading into the cartridge (FIG. 14a). An immiscible layer of silicone oil provides an evaporation barrier and a fluidic interconnect between reagent wells for transfer of the magnetic beads. By isolating the reagents in thin-walled thermoformed wells, the thermal mass of the reaction chamber can be spatially isolated for targeted, rapid thermocycling leading to faster turnaround times than traditional bulky PCR systems.

Once the sample is mixed with the magnetic bead buffer and loaded into the cartridge, the viral particles are lysed due to surfactant and heating in the first well to allow for electrostatic binding of viral RNA to the charge-functionalized magnetic beads (FIG. 14b), Transfer of the beads into the second well exchanges the beads into a pH neutral wash buffer for removal of binding salts and any contaminants in the sample which may inhibit PCR (FIG. 14c). Finally, sequential transfer of the beads into the alkaline (pH 8.5) PCR wells allows for neutralization of the bead coating and partial release of captured RNA into each PCR reaction well (FIG. 14d) for amplification and fluorescence detection. To achieve under 30-minute turnaround time, sample preparation from lysis to completion of elution takes around 6 minutes, followed by 5 minutes of reverse transcription, and 50 cycles of PCR thermocycling in under 18 minutes.

Compared to previously developed magnetofluidic cartridges, the PROMPT cartridge in this work includes several key innovations. A wax plug between the sample well and wash well seals off the oil and downstream reagents to immobilize all downstream fluids during transport and handling, which allows for full range of tilting and moderate shaking without reagent leakage. After the user injects the sample into the cartridge port, any excess sample can escape into an overflow reservoir and the port is sealed with an adhesive strip to providing an additional layer of safety from sample contamination and spill of infectious materials. The most critical innovation in this work is the inclusion of an additional PCR well for higher levels of multiplexing coupled with a sequential elution strategy. Sequential elution takes advantage of the incomplete release of captured nucleic acids to aliquot RNA into separate reaction buffers. As the beads are exposed to each new buffer, the captured nucleic acids will be released until an equilibrium between the concentration of analyte on the bead surface and in the reaction buffer is reached. We have demonstrated this technique has potential to expand multiplexing up to at least six separate reactions. This flexibility in multiplexing provides an option to expand the future cartridges to include additional targets for other variants or a larger panel of pathogens.

Instrument Design and Sample Processing

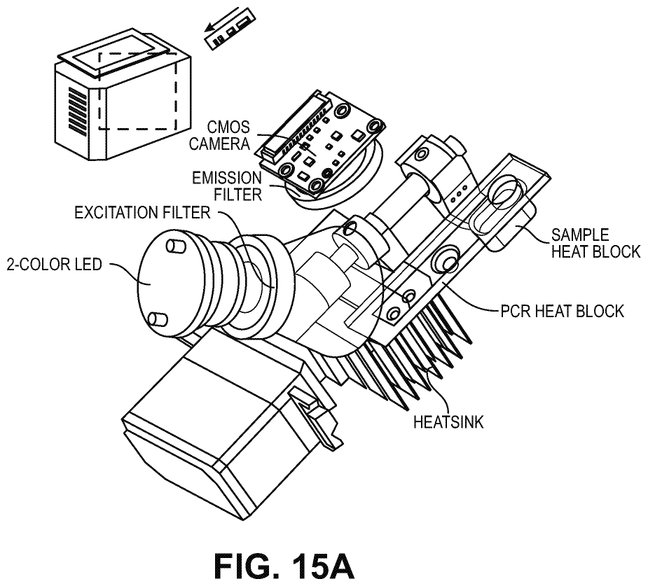

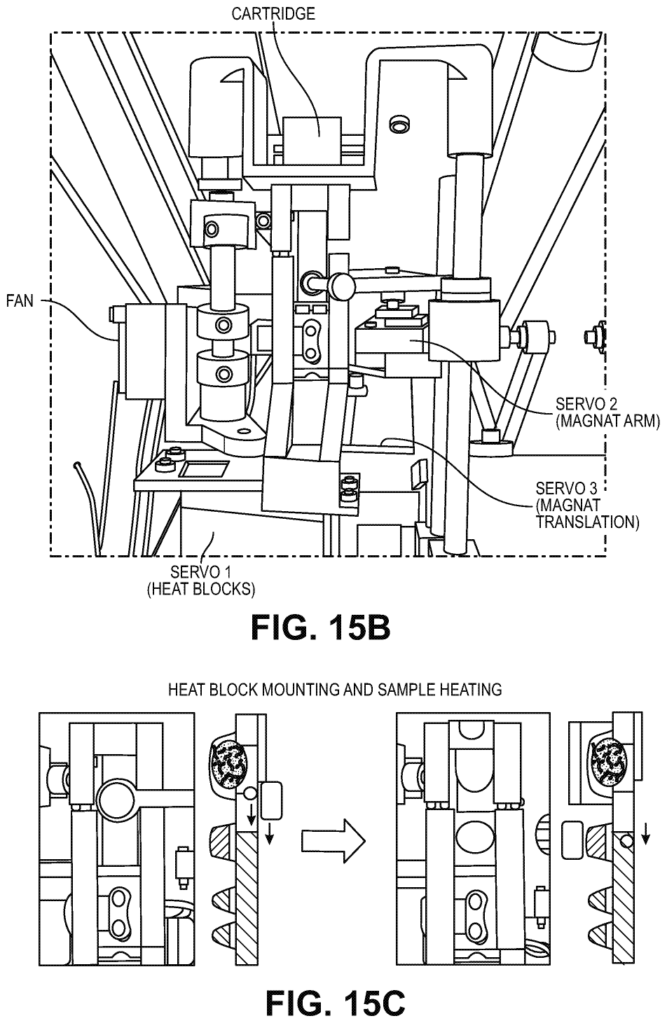

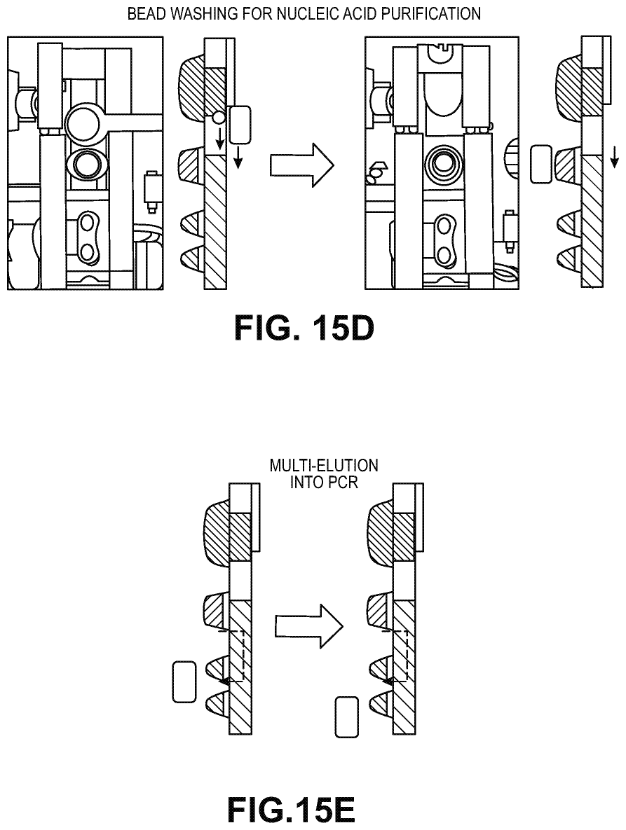

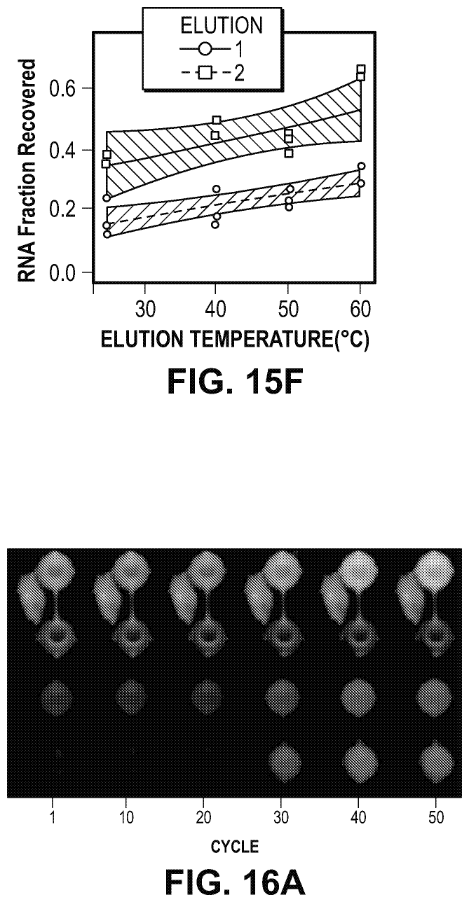

The PROMPT instrument contains all necessary components for transfer of magnetic beads through the cartridge, temperature control to melt wax seals and conduct RT-PCR, and optics for fluorescence excitation and detection (FIG. 15a-b). Instead of complex fluidics, valves, pressure controllers typically found in microfluidic instrumentation, the components here include primarily low-cost hobby servo motors and off-the-shelf LED and CMOS camera parts. Once the cartridge is inserted into the instrument, it is detected with the CMOS camera, which uses the fluorescent outline of the PCR wells to determine if the cartridge is properly positioned. The fluorescence detection uses dual bandpass filters over the CMOS camera for emission, and a 2-color LED for excitation permits multi-color detection without moving parts by alternating blue and red LED illumination for FAM and Cy5 fluorophores, respectively. If the cartridge has been inserted fully, then the first servo motor involved rotates a shaft to mount both the sample heat block and PCR heat block onto the cartridge. With the heat blocks mounted, a power resistor heats the sample heat block to 100° C. for 80 seconds to both promote viral lysis and melt the wax plug which then floats toward the top of the cartridge leaving a clear passage for transfer of the magnetic particles (FIG. 15c).

A second servo motor serves to swivel two opposing neodymium permanent magnets to the bottom or top of the cartridge to pellet beads into reagent wells or extract them into the oil layer, while the final third servo motor translates this magnet arm along the length of the cartridge for transfer of the beads between wells (FIG. 15b). This magnetic transfer paradigm allows the beads to be transferred anywhere along the long axis of the cartridge for built-in compatibility for cartridge designs with varying well number, dimensions, and positioning. With the wax melted, the beads are collected out of the sample well to the top of the cartridge and transferred into the wash buffer well to remove contaminants that might inhibit function of the downstream PCR assays (FIG. 15d). After repeated alternated application of the top and bottom magnets for three exchanges of the beads into and out of the wash buffer, the beads are finally transferred sequentially into the PCR wells (FIG. 15e). Each well receives the beads for 1 minute while the PCR buffers are heated to 55° C. to encourage release of the capture RNA and initiate reverse transcription. While the first well receives a larger fraction of eluted RNA (˜40-60%) than the second well (˜10-30%), this multi-elution strategy permits some control over the release of the RNA with higher elution temperature providing a higher fraction of RNA recovered in each well (FIG. 15f).

Immediately after elution, generation of cDNA and amplification is carried with reverse transcription and PCR thermocycling. Temperature in both wells is simultaneously controlled by the PCR heat block with heat block temperature set with 2 second holds at 100° C. followed by 55° C. for cDNA denaturation and annealing/extension respectively. Miniaturization of the PCR heat block's thermal mass and the use of copper's high thermal conductivity (˜400 W/m-K) enables rapid changes in temperature powered by a heatsinked thermoelectric element.

Assay Cartridge Analytical Sensitivity and Specificity

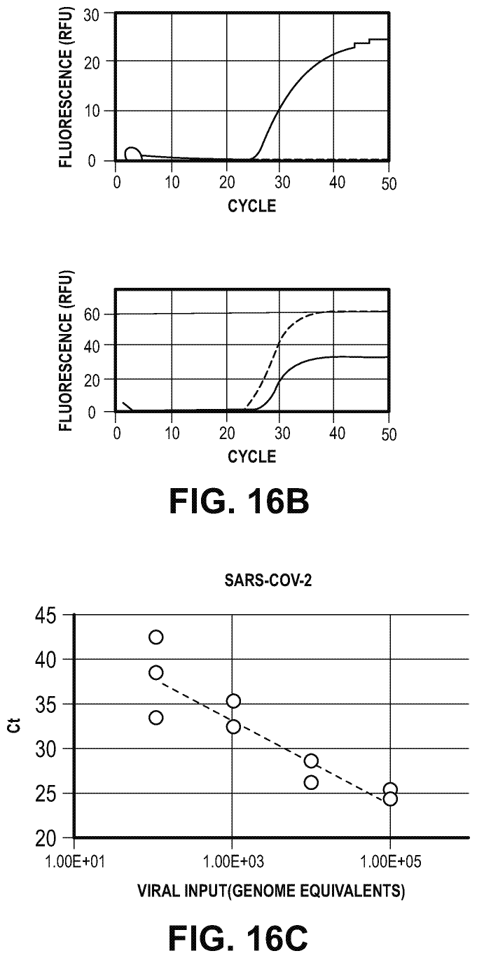

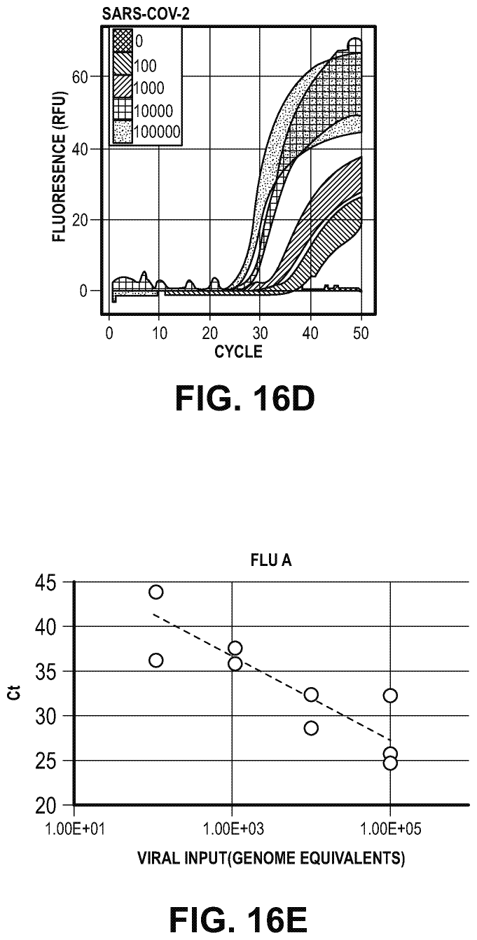

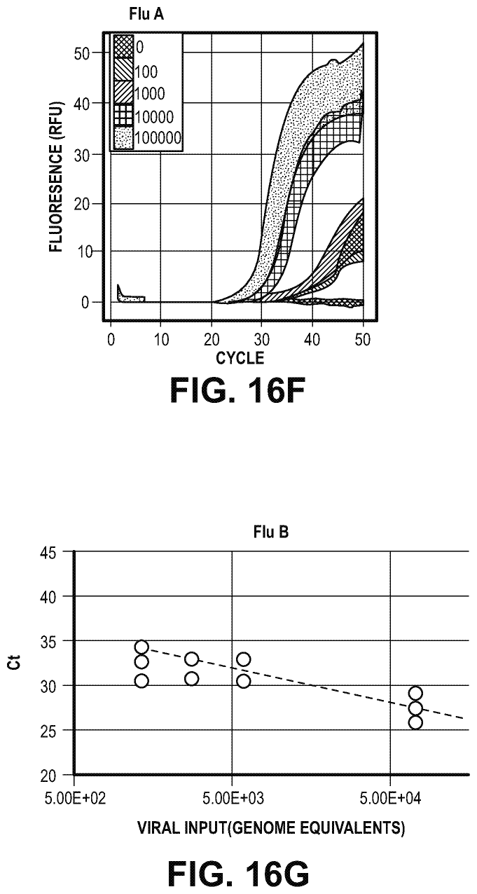

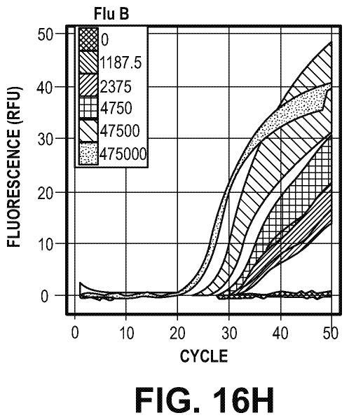

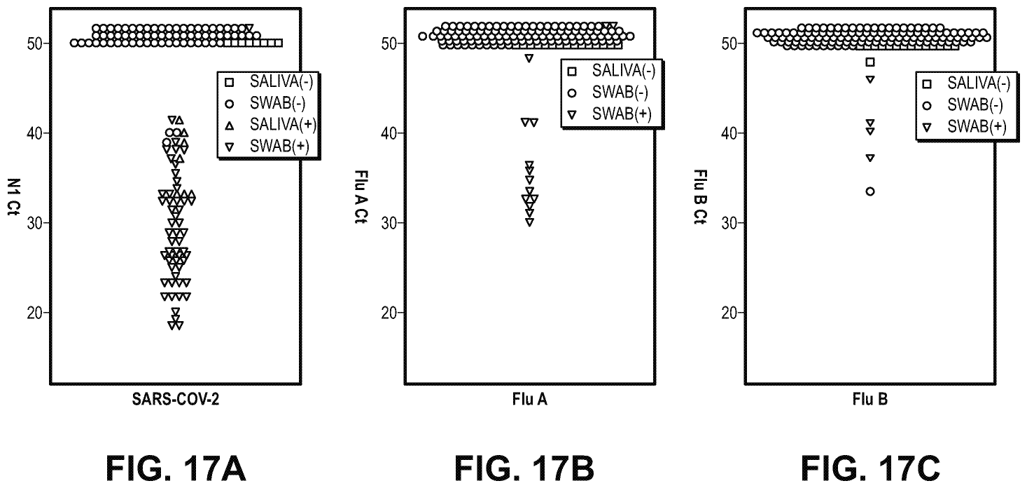

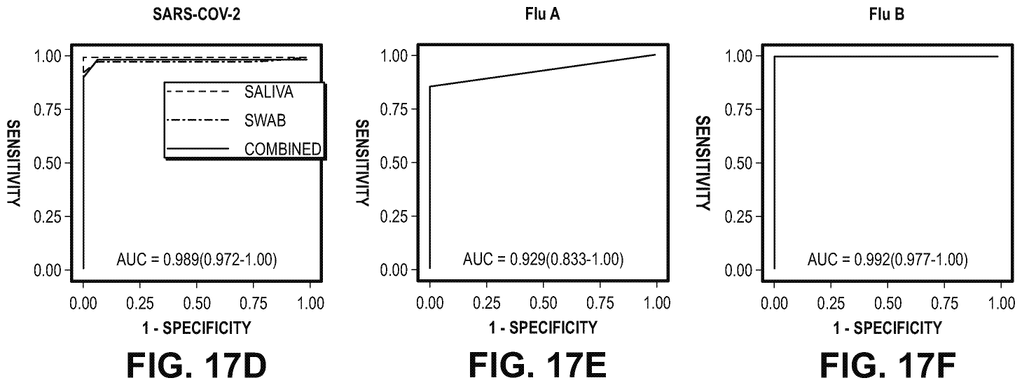

Throughout thermocycling, the CMOS camera takes a picture for each fluorescence channel at the end of each cycle's annealing step (FIG. 16a). The pixel intensity for each well is isolated and averaged to generate a real-time fluorescence curve (FIG. 16b), from which the cycle threshold (Ct) is determined with an automated thresholding algorithm. Detection of amplification and Ct calculation is conducted at the end of each cycle in real-time for early reporting to the user. For high viral load samples (Ct<20), detection of targets may be reported within 18 minutes from insertion of the cartridge.

Using the respiratory panel cartridge design, serial dilutions of inactivated SARS-CoV-2, influenza A, or influenza B viral particles were spiked into 50 μL. of mock swab sample buffer and loaded into cartridges with magnetic bead solution. Each dilution was run in triplicate. Both SARS-CoV-2 and Influenza A were detectable down to 100 copies input corresponding to 2 copies/μL of sample (FIG. 16c-f). Influenza B was detected in serial dilutions from 10⁴ to 50 CEID₅₀ input, which converted to genome equivalent copy number resulting in a limit of detection of 24 copies/μL of sample (FIG. 16g,h). We have also demonstrated detection of SARS-CoV-2 spiked into saliva with a limit of detection of 13 copies/4, To assess the specificity of the assay, the cartridges were run using a panel of 14 viral and bacterial pathogens.

Clinical Sample Validation

Using the cartridge model for detection of SARS-CoV-2 variants we evaluated clinical samples from Johns Hopkins Hospital (JHH) as well as extracted RNA from 3.1.1.7, B.1.135, and P.1. variants. All samples were classified into three categories as either (1) 3.1.1.7, (2) B.1.135/P.1, or (3) other indicating it did not possess the characteristic mutations of current variants of concern (Table 1), All JHH samples (n=4) amplified N1, ORF1a, and spike targets indicating they were not one of the variants of concern. Samples previously classified as B.1.1.7 variants (n=4) by sequencing produced fluorescent amplification signals for N1 on cartridge, but no amplification of either the ORF1a or the spike targets and were accordingly classified properly. The samples characterized as B.1.135 (n=3) by sequencing produced signals for N1 and spike, but did not amplify the ORF1a target resulting in proper classification as B.1.135 or P.1.

TABLE 1
Detection of SARS-CoV-2 Variants

| Sample | N1-Ct | ORF1a-Ct | Spike-Ct | Classification |
|---|---|---|---|---|
| JHH #1 | 30.39 | 32.57 | 32.64 | Other |
| JHH #2 | 30.78 | 34.44 | 33.85 | Other |
| JHH #3 | 28.73 | 38.10 | 27.49 | Other |
| JHH #4 | 28.33 | 45.57 | 27.54 | Other |
| B.1.1.7 #1 | 26.03 | Not detected | Not detected | B.1.1.7 |
| B.1.1.7 #2 | 32.03 | Not detected | Not detected | B.1.1.7 |
| B.1.1.7 #3 | 34.38 | Not detected | Not detected | B.1.1.7 |
| B.1.1.7 #4 | 30.13 | Not detected | Not detected | B.1.1.7 |
| B.1.135 #1 | 33.03 | Not detected | 37.59 | B.1.135 or P.1 |
| B.1.135 #2 | 28.29 | Not detected | 37.59 | B.1.135 or P.1 |
| B.1.135 #3 | 32.78 | Not detected | 31.49 | B.1.135 or P.1 |

To assess performance of the respiratory pathogen panel cartridges, we tested clinical swab eluates (n=116) and passive drool saliva (n=14). As a comparator assay, samples were first assessed with a benchtop assay adapted from the CDC recommended protocol. Of the swab samples, 54 were positive for SARS-CoV-2, 14 were Flu A positive, and 4 were Flu B positive, Saliva samples contained 7 SARS-CoV-2 positives of which all were correctly classified with the cartridge assay. Only one of the SARS-CoV-2 samples went undetected, which was a swab eluate with a relatively late Ct (37.2) by the benchtop comparator assay indicating a low viral titer. Of the negative SARS-CoV-2 samples, three false-positives were detected using cartridges, all with late Cts (>39) indicative of possible low-level contamination from other positive samples. Overall sensitivity and specificity for detection of SARS-CoV-2 was 98.4% (95% confidence interval: 88.5-100%) and 95.7% (89.9-100%), We excluded 5 negative samples and 4 SARS-CoV-2 positive samples detected in the comparator assay that produced invalid cartridge results (no amplification of control or any other targets).

The cartridge Flu A assay missed detection of 2 out of the 14 positives which both had the lowest viral load of the Flu A samples (Ct>35), but yielded fully concordance with negative samples, resulting in a sensitivity and specificity of 85.7 (64.3-100%) and 100% respectively. For Flu B, all 4 positives were detected in cartridge with just one false-positive resulting in a specificity of 98.4% (97.6-100%).

Discussion

As more SARS-CoV-2 variants emerge, they pose grave threats to the worldwide public health infrastructure with potential for higher transmission and vaccine evasion. It is widely predicted that once under control, SARS-CoV-2 will continue to spread as an endemic disease alongside other respiratory pathogens like the influenza viruses. There is an urgent need for affordable and mass-produced testing options that can provide rapid, multiplexed results for identification of variants and to allow future screening of SARS-CoV-2 with other diseases that produce similar respiratory symptoms. Compared to the intricate multi-component designs of current commercially available cartridges, our simple thermoplastic cartridges demonstrate great potential as a highly cost-effective and scalable solution, which is amenable to industrial manufacturing techniques such as roll-to-roll molding, lamination, and die-cutting.

Numerous companies and researchers propose the use of isothermal NATs as PCR alternatives to leverage the sensitivity of RNA-based detection while reducing cost with simplified instrumentation or “instrumentation-free” testing. These tests have been developed using loop-mediated isothermal amplification (LAMP), recombinase polymerase amplification (RPA), or CRISPR-Cas based detection of viral RNA. Although the developers of these isothermal solutions claim these methods simplify tests and instrumentation by removing the need for thermocycling, there is often little acknowledgment of the need for manual processes to purify and concentrate sample RNA to achieve high sensitivity assays. Our magnetofluidic cartridges completely automate nucleic acid purification and concentration and minimize user intervention for reading results.

In terms of expanding capacity for detecting multiple SARS-CoV-2 variants or other respiratory pathogens, these isothermal tests typically lack the ability to multiplex detection of several pathogens without either setting up multiple separate tests or requiring further post-processing steps for detection. Post-processing for readout of results adds an additional manual step which reduces the likelihood of adoption where a high-volume of tests requires minimal hands-on time. Any handling of amplified product raises risks of contamination which would compromise test specificity. Low-cost assays using minimal instrumentation also have minimal connectivity, making streamlined acquisition of patient results for surveillance difficult and can result in under-reporting of cases. For widespread adoption, on-site multiplexed diagnostic methods need a user workflow as simple, fast, and affordable as lateral flow strips while maintaining connectivity for connecting to clinical databases for improving surveillance. The PROMPT platform meets these needs in a compact user-friendly format that is compatible with various sample types including PBS, universal transport media, and saliva.

For realistic deployment, there are a few limitations to the current platform that must be addressed. In particular, the current cartridges are not shelf stable for prolonged storage at room-temperature and are refrigerated or frozen prior to use. We are currently investigating techniques for built-in storage of dry reagents to allow stability at ambient conditions. To include testing for additional variants or respiratory pathogens, the cartridge would need to be expanded from the current 2-well design with additional PCR wells for higher multiplexing. Given the limited clinical sample volume available in this study, assay design used a maximum 50 μL input per sample, though further improvement to sensitivity to prevent false-negatives may be achieved by adapting the cartridge and binding buffer to be compatible with larger volumes of sample.

Methods

RT-PCR Assay Composition

Quantitative Synthetic RNA from SARS-Related Coronavirus 2 (NR-52358) was obtained through the BEI Resources Repository, National Institute of Allergy and Infectious Diseases (NINE)), National Institutes of Health (NIH), and was stored at −80° C. upon receipt. This preparation includes fragments from the open reading frame 1ab (ORF1ab), envelope (E), and nucleocapsid (N) regions. Gamma-irradiated viral particles from SARS-Related Coronavirus 2 (Isolate USA-WA1/2020), Influenza A/Puerto Rico/8/1934-9VMC2(NR-29027), and Influenza B virus B/Nevada/03/2011 (BV) (NR-44023) were obtained through the BEI Resources Repository and was stored at −80° C. upon receipt. Quantitative Synthetic SARS-CoV-2 RNA Control 14 (8.1.1.7_710528) was purchased from Twist Bioscience (CA, USA).

A 7.5-μL duplexed PCR probe assay was composed of 1×qScript XLT 1-Step RT-qPCR ToughMix (QuantaBio, USA), 0.1 U/μL SpeedSTAR HS DNA polymerase (Takara Bio USA, Inc), 0.1 U/μL AccuStart H Taq DNA polymerase (QuantaBio, USA), 1 mg/mL BSA (New England Biolabs), 0.1% Tween-20 (Sigma Aldrich, Mo., USA) and primer-probe pairs. For duplexed assay for N1 and control RNA, the assay contains 1 μM each N1 primer, 0.45 μM each Luciferase primer, 1 μM N1 probe and 0.25 μM Luciferase probe. For duplexed assay for influenza A and influenza B, the assay contains 0.5 μM each influenza A primer, 1 μM each influenza B primer, 0.25 μM influenza A probe and 0.5 μM influenza B probe. For duplexed assay of SARS-CoV-2 variant detection, the assay contains 0.67 μM each Yale Spike Δ69-70 primer, 0.3 μM each Yale ORF1a Δ3675-3677 primer, 0.2 μM Yale Spike Δ69-70 probe and 0.2 μM ORF1a Δ3675-3677 probe. All oligonucleotides, including primers and fluorescently labeled DNA probe (sequences in Table S4) were purchased from Integrated DNA Technologies (IDT; Coralville, Iowa, USA).

Cartridge Fabrication and Assembly

The magnetofluidic cartridges were assembled from three thermoplastic layers. The bottom layer was fabricated by thermoforming 10 mil (˜0.25 mm) thick polyethylene terephthalate glycol (PETG) sheet (Welch Fluorocarbon) over 3D-printed molds (Form 2, Formlabs) designed in Fusion 360 (Autodesk) to produce extruded wells. The middle layer was laser-cut from 0.75 mm thick acrylic (ePlastics) with pressure-sensitive adhesive (PSA) (9472LE adhesive transfer tape, 3M) laminated on both sides. The top layer was laser-cut from 1.5 mm thick clear acrylic sheet (McMaster-Carr, USA) with Teflon tape (McMaster-Carr) laminated to one side and patterned by laser-etching.

To load reagents into the cartridge wells, the thermoformed section and acrylic middle layer were first joined with PSA, followed by dispensing 7.5 μL PCR solution and 50 μL wash buffer (W14, ChargeSwitch Total RNA Cell Kit, Invitrogen) into corresponding wells. With aqueous reagents pre-loaded, the cartridge was sealed by lamination with the top layer using the PSA on the other side of the middle layer, Once sealed 420 μL silicone oil (100 cSt, Millipore-Sigma) was injected through the sample injection port to cover the wells and fill the remaining space within the cartridge except for the first well. To create the wax plug in the first well, 40 μL of molten docosane wax (Millipore-Sigma) was dispensed into the sample port and melted into the oil with a custom heating rig followed by cooling at room temperature to solidify. The cartridge was either used immediately or the sample injection port was sealed with adhesive tape (Scotch Magic Tape, 3M) and the cartridge stored on ice or frozen until use.

Instrument Design

Laser-cut and 3D-printed housing and fixtures of the instrument was designed in Fusion 360. External walls were laser-cut from ⅛″ thick acrylic (McMaster-Carr) and 3D-printed components were fabricated using an SLA (Form 2, Black Resin, Formlabs) or FDM printer (Prusa Mini, Prusament PETG, Prusa research). A 5-inch HDMI touchscreen (Elecrow) was mounted on top of the instrument to allow user input with the graphic user interface (GUI) designed in python Tkinter, Motorized actuation of an arm containing opposing neodymium magnets (KU Magnetics) was implemented with a micro servo motor (TowerPro SG51R) mounted on a carriage guided along two aluminum rails by a second servo motor (Hitec HS-485HB). A third servo motor (Hitec HS-485HB) pivoted an aluminum rod to swivel the heat blocks onto the cartridge. The sample well heat block was custom machined out of 6061 aluminum and mounted onto a power resistor (Riedon PF1262-5RF1) with a steel M3 screw, while the PCR heat block was machined from 145 copper and mounted onto a thermoelectric element (Peltier Mini Module, Custom Thermoelectric) and heatsink using thermally conductive epoxy (Arctic Alumina Thermal Adhesive, Arctic Silvery Temperature of the heat blocks was monitored with a thermistor probe (GA100K6MCD1, TE Connectivity) epoxied directly adjacent to the wells, A 5V fan (Sunon) provided cooling to the heatsink.

Cartridges were illuminated using the red and blue channels of a 3-color RGB LED (Vollong) passed through a focusing lens (10356, Carclo) and dual bandpass excitation filter (59003m, Chroma). Fluorescence was captured with a CMOS camera (Pi NoIR Camera V2, Raspberry Pi) through a dual bandpass emission filter (535-700DBEM, Omega Optical). An Arduino Nano microcontroller coordinated control of the LEDs, fan, and motors, and a Raspberry Pi 3B+ ran the GUI, processed fluorescence images, monitored thermistor readings and provided current to the heat blocks via a motorshield (Dual TB9051FTG Motor Driver, Pololu). Power to the instrument was supplied with a 7.5V 45 W wall adapter (MEAN WELL GST60A07-P1J).

Cartridge Limit of Detection Determination

LoDs of the PROMPT testing for swab and saliva samples were determined using contrived specimens. To prepare the contrived samples, a serial dilution of viral particles with known concentrations were spiked into pooled (n=4) clinical specimens (PCR confirmed negative by the Johns Hopkins Clinical Microbiology Lab). Each concentration was tested at a minimum of three times, and the LoDs were determined when one of the replicates showed negative. Fifty microliters of swab eluate or five microliters of saliva was first mixed with 150 μL magnetic bead binding buffer (consisting of 0.67 mg/mL ChargeSwitch beads, 0.5M KCl in 100 mM aqueous MES, and 10⁵ copies of Luciferase RNA internal control) followed by injecting the entire mixture into the sample port of the cartridge. The cartridge was then analyzed in the PROMPT instrument.

Clinical Sample Testing

Clinical swab and saliva specimens were collected under an IRB. Specimens were de-identified and blinded before testing. Nasopharyngeal swabs were eluted in 3 mL of Universal Transport Medium and 50 μL of the eluate from each swab was loaded into the PROMPT cartridge for testing. Passive drooled saliva specimens were collected without using any medium. Five microliters of each saliva specimen was loaded into the PROMPT cartridge for testing. A modified CDC testing protocol for swabs and FDA EUA authorized SalivaDirect protocol for saliva were employed to test all the clinical specimens on a BIO-RAD CFX96 Touch Real-Time PCR System as reference.

Swab: Either 50 μL of swab eluate or 5 μL of saliva was first mixed with 150 μL magnetic bead binding buffer (0.67 mg/mL ChargeSwitch beads, 0.5M KCl in 100 mM aqueous MES, 1 μL Luciferase control RNA) followed by injecting the entire mixture into the sample port of the cartridge.

For clinical sample testing for detection of SARS-CoV-2 variants, the RNA samples were extracted from clinical samples using the Chemagic 360 extractor method. 2 μL. of extracted RNA was mixed with 150 μL magnetic bead binding buffer following by injection it into the sample port of the cartridge.

While the foregoing disclosure has been described in some detail by way of illustration and example for purposes of clarity and understanding, it will be clear to one of ordinary skill in the art from a reading of this disclosure that various changes in form and detail can be made without departing from the true scope of the disclosure and may be practiced within the scope of the appended claims. For example, all the methods, devices, systems, computer readable media, and/or component parts or other aspects thereof can be used in various combinations. All patents, patent applications, websites, other publications or documents, and the like cited herein are incorporated by reference in their entirety for all purposes to the same extent as if each individual item were specifically and individually indicated to be so incorporated by reference.

1. A magnetofluidic cartridge, comprising:
a body structure that defines a channel and a plurality of wells disposed substantially within the body structure, wherein the channel is capable of fluidly communicating with the plurality of wells and wherein the plurality of wells comprises at least one sample inlet well and at least one sample analysis well;
at least one port disposed through a top surface of the body structure at least proximal to the sample inlet well, which port fluidly communicates with the channel;
a sealing mechanism operably connected, or connectable, to at least the top surface of the body structure and/or the port, which sealing mechanism seals the port when the sealing mechanism is in a closed position;
a plurality of magnetic particles disposed in at least the sample inlet well;
at least one processing reagent disposed in at least the sample analysis well and/or in at least one other chamber that fluidly communicates with the sample analysis well;
a first temperature sensitive material disposed in a substantially solid state in the channel between the sample inlet well and the sample analysis well and/or at least partially within the sample inlet well and/or the sample analysis well, which first temperature sensitive material fluidly partitions the sample inlet well and the sample analysis well from one another when the first temperature sensitive material is in the substantially solid state; and,
a sealing fluid disposed in at least a portion of the channel, which sealing fluid is immiscible with at least the plurality of magnetic particles and with the processing reagent.

2. (canceled)

3. The magnetofluidic cartridge of claim 1, wherein the plurality of wells further comprises at least one overflow reservoir that is structured to receive excess sample, when the sample is received in the sample inlet well through the port.

4. The magnetofluidic cartridge of claim 1, further comprising at least one vent orifice disposed through at least a portion of the body structure or through at least one layer, which vent orifice fluidly communicates with the channel and is structured to vent one or more gases from the channel at least when the magnetofluidic cartridge is heated.

5. (canceled)

6. (canceled)

7. The magnetofluidic cartridge of claim 1, wherein the first temperature sensitive material fluidly partitions the sample inlet well and the sample analysis well from one another when the first temperature sensitive material is in the substantially solid state to produce a first region that comprises the sample inlet well and at least a first portion of the channel and a second region that comprises the sample analysis well and at least a second portion of the channel, and wherein the sealing fluid is disposed at least in the second portion of the channel of the second region such that the processing reagent is substantially contained within the sample analysis well.

8. The magnetofluidic cartridge of claim 1, wherein the first temperature sensitive material is insoluble in aqueous materials; less dense than at least the plurality of magnetic particles and the sealing fluid; less dense than a sample and/or assay reagents; in the substantially solid state at a temperature less than about 40° C.; and/or in at least a partially fluid state at a temperature more than about 40° C.

9.-11. (canceled)

12. The magnetofluidic cartridge of claim 1, wherein the sealing fluid is a hydrophobic fluid.

13. (canceled)

14. (canceled)

15. The magnetofluidic cartridge of claim 1, wherein the plurality of magnetic particles comprises coated magnetic nanoparticles that are coated with silica and/or a coating material that electrostatically binds nucleic acids.

16. The magnetofluidic cartridge of claim 1, wherein at least one of the plurality of wells comprises a wall sufficiently thin to allow a heat transfer rate such that a nucleic acid amplification assay can be completed in less than 20 minutes.

17. (canceled)

18. The magnetofluidic cartridge of claim 1, wherein the processing reagent is lyophilized.

19. (canceled)

20. The magnetofluidic cartridge of claim 1, further comprising a second temperature sensitive material disposed in a substantially solid state at least proximal to the sample analysis well, which second temperature sensitive material fluidly partitions the processing reagent disposed in the sample analysis well and the sealing fluid disposed in the second portion of the channel of the second region from one another when the second temperature sensitive material is in the substantially solid state.

21. The magnetofluidic cartridge of claim 20, further comprising at least one reconstitution buffer disposed in the sample analysis well, wherein the second temperature sensitive material separates the reconstitution buffer from the processing reagent.

22. (canceled)

23. (canceled)

24. The magnetofluidic cartridge of claim 1, wherein the sealing fluid comprises a silicone oil.

25. The magnetofluidic cartridge of claim 1, wherein the plurality of magnetic particles is in a dried state.

26. (canceled)

27. The magnetofluidic cartridge of claim 1, further comprising at least one control reagent disposed in at least the sample inlet well and/or in at least the other chamber, which control reagent is in a dried state.

28. (canceled)

29. The magnetofluidic cartridge of claim 1, further comprising at least one sample comprising at least one biomolecule disposed in the sample inlet well.

30. The magnetofluidic cartridge of claim 29, wherein the biomolecule comprises at least one nucleic acid and/or at least one protein.

31. The magnetofluidic cartridge of claim 1, further comprising at least one buffer, at least one salt, and/or at least one lytic reagent disposed in the sample inlet well and/or in the other chamber.

32. A kit comprising the magnetofluidic cartridge of claim 1.

33. A magnetofluidic device, comprising:
a cartridge assembly structured to accept and secure the magnetofluidic cartridge of claim 1;
a temperature modulation assembly arranged proximate to the cartridge assembly, which temperature modulation assembly comprises at least one heat source that selectively thermally communicates with one or more of the plurality of wells and/or the channel of the magnetofluidic cartridge; and,
a magnetic particle manipulation assembly arranged proximate to the cartridge assembly, which magnetic particle manipulation assembly comprises a pair of magnets arranged to be on opposing sides of the magnetofluidic cartridge and which are substantially aligned along a line that will be transverse to the magnetofluidic cartridge such that the line can be aligned with one or more of the plurality of wells in the magnetofluidic cartridge,
wherein the pair of magnets are moveable along the line relative to the magnetofluidic cartridge, or a strength of the pair of magnets is adjustable such that the plurality of magnetic particles when contained within the one or more wells can be drawn out of and back into the one or more wells during operation.

34. A method of detecting at least one biomolecule in a sample, the method comprising:
loading the sample into a sample inlet well of a magnetofluidic cartridge that comprises:
a body structure that defines a channel and a plurality of wells disposed substantially within the body structure, wherein the channel is capable of fluidly communicating with the plurality of wells and wherein the plurality of wells comprises at least one sample inlet well and at least one sample analysis well;
at least one port disposed through a top surface of the body structure at least proximal to the sample inlet well, which port fluidly communicates with the channel;
a sealing mechanism operably connected, or connectable, to at least the top surface of the body structure and/or the port, which sealing mechanism seals the port when the sealing mechanism is in a closed position;
a plurality of magnetic particles disposed in at least the sample inlet well;
at least one processing reagent disposed in at least the sample analysis well;
a first temperature sensitive material disposed in a substantially solid state in the channel between the sample inlet well and the sample analysis well and/or at least partially within the sample inlet well and/or the sample analysis well, which first temperature sensitive material fluidly partitions the sample inlet well and the sample analysis well from one another when the first temperature sensitive material is in the substantially solid state; and,
a sealing fluid disposed in at least a portion of the channel, which sealing fluid is immiscible with at least the plurality of magnetic particles and with the processing reagent;
positioning the sealing mechanism in the closed position;
agitating the magnetofluidic cartridge such that the biomolecule binds to the plurality of magnetic particles to produce a bound biomolecule;
removing the first temperature sensitive material from partitioning the sample inlet well and the sample analysis well from one another;
moving the bound biomolecule from the sample inlet well to the sample analysis well; and,
detecting the biomolecule and/or a molecule derived therefrom in the sample analysis well, thereby detecting the biomolecule in the sample.

35. (canceled)

36. (canceled)


SEQUENCE LISTING (7 sequences)

SEQ ID NO: 1 - DNA, 20 bp, Artificial Sequence
  Description of Artificial Sequence Synthetic primer
gaccccaaaatcagcgaaat

SEQ ID NO: 2 - DNA, 24 bp, Artificial Sequence
  Description of Artificial Sequence Synthetic primer
tctggttactgccagttgaatctg

SEQ ID NO: 3 - DNA, 15 bp, Artificial Sequence
  Description of Artificial Sequence Synthetic probe
tacgtttggtggacc

SEQ ID NO: 4 - DNA, 77 bp, Artificial Sequence
  Description of Artificial Sequence Synthetic oligonucleotide
gcagccactggtaacaggatctgatgttgaaggacggattatatcgggactcactataactgtaggcaccatcaatc

SEQ ID NO: 5 - DNA, 20 bp, Artificial Sequence
  Description of Artificial Sequence Synthetic primer
gcagccactggtaacaggat

SEQ ID NO: 6 - DNA, 30 bp, Artificial Sequence
  Description of Artificial Sequence Synthetic primer
gattgatggtgcctacagttatagtgagtc

SEQ ID NO: 7 - DNA, 18 bp, Artificial Sequence
  Description of Artificial Sequence Synthetic probe
tccgtccttcaacatcag